(19) United States
(12) Patent Application Publication
(10) Pub. No.: US 2008/0112746 A1
(43) Pub. Date: May 15, 2008

(54) Printing system, image forming apparatus, image forming method, control apparatus, computer readable medium, and computer data signal

(75) Inventor: Yoshikazu Yamamoto, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/785,156

(22) Filed: Apr. 16, 2007

(30) Foreign Application Priority Data
Nov. 13, 2006 (JP) P2006-306155

(51) Int. Cl. G03G 15/00

(52) U.S. Cl. 399/385

(57) ABSTRACT

A printing system includes: plural image forming units that forms an image on a recording medium; and plural cutting units that are arranged at plural locations along a conveying path in which the images are formed on the recording medium, the conveying path conveying the recording medium to the plural image forming units, and that cuts the recording medium based on a state where the recording medium is being conveyed.

### CROSS-REFERENCE TO RELATED APPLICATIONS

This application is based on and claims priority under 35 U.S.C. 119 from Japanese Patent Application No. 2006-306155 filed Nov. 13, 2006.

### BACKGROUND

### 1. Technical Field

The present invention relates to a printing system for forming images, an image forming apparatus, an image forming method, a control apparatus, a computer readable medium, and a computer data signal.

### SUMMARY

According to an aspect of the present invention, a printing system includes: a plurality of image forming units that forms an image on a recording medium; and a plurality of cutting units that are arranged at a plurality of locations along a conveying path in which the images are formed on the recording medium, the conveying path conveying the recording medium to the plurality of image forming units, and that cuts the recording medium based on a state where the recording medium is being conveyed.

### BRIEF DESCRIPTION OF THE DRAWINGS

Exemplary embodiment of the present invention will be described in detail based on the following figures, wherein:

FIG. 1 is a diagram showing the general configuration of a printing system according to a first embodiment of the present invention;

FIG. 2 is a diagram showing the arrangement of a first printer;

FIG. 3 is a diagram showing example page registration marks and example color registration marks;

FIG. 4 is a functional diagram showing the arrangement of the conveying control associated sections of a control computer, a feeding controller, a first printer controller, a buffer unit controller, an obverse/reverse side inversion unit controller, a second printer controller and a take-up controller;

FIG. 5 is a flowchart showing example web conveying processing performed by the printing system;

FIGS. 6A to 6D are diagrams showing a process during which a cutter cuts a web in a direction substantially perpendicular to a conveying path;

FIGS. 7A to 7C are diagrams for explaining the position of the blade edge of a cutter;

FIGS. 8A to 8D are diagrams showing the structure of a cutter that includes a safety mechanism for preventing accidents caused by a blade edge;

FIG. 9 is a diagram showing the general configuration of a printing system according to a second embodiment of the present invention;

FIG. 10 is a diagram showing the arrangement of a K color printer;

FIGS. 11A to 11C are diagrams for explaining the structure of a cutter;

FIG. 12 is a functional diagram showing the arrangement of the conveying control associated sections of a control computer, feeding controller, a K color printing controller, a first buffer unit controller, a C color printing controller, a second buffer unit controller, an M color printing controller, a third buffer unit controller, a Y color printing controller and a take-up controller;

FIG. 13 is a flowchart showing the first half of the web conveying processing performed by the printing system; and

FIG. 14 is a flowchart showing the second half of the web conveying processing performed by the printing system.

### DETAILED DESCRIPTION

### First Embodiment

A first embodiment of the present invention will now be described in detail while referring to the accompanying drawings.

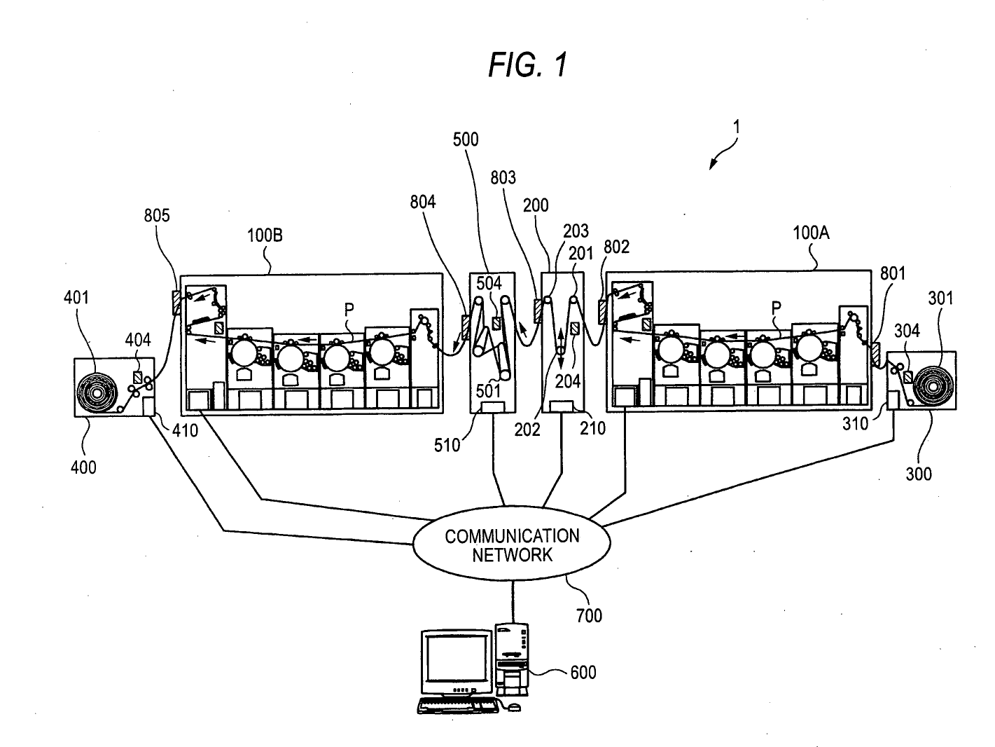

FIG. 1 is a diagram showing the general configuration of a printing system 1 according to this embodiment. The printing system 1 shown in FIG. 1 is a system wherein two so-called web printers, which form images on a web P, a belt-like continuous form employed as an example recording medium, are coupled, one with the other, to form images on both sides of the web P. That is, the printing system 1 in this embodiment comprises, from upstream to downstream in a direction in which the web P is conveyed: a web feeding apparatus 300; a first printer 10A, which is an example first image forming apparatus arranged upstream; a buffer unit 200 (which will be described later), which serves as an example medium conveying unit; an obverse/reverse side inversion unit 500; a second printer 100B, which is an example second image forming apparatus arranged downstream; and a web take-up apparatus 400.

The printing system 1 for this embodiment also comprises a control computer 600, which is an example control apparatus that controls the operations of the individual apparatuses of the printing system 1. The control computer 600 is connected via a communication network 700, which is an example communication unit, to the web feeding apparatus 300, the first printer 100A, the buffer unit 200, the obverse/reverse side inversion unit 500, the second printer 100B and the web take-up apparatus 400.

The web feeding apparatus 300 loads a web P, as a web roller 301, and feeds the web P to the first printer 100A.

The web feeding apparatus 300 includes: a feeding abnormality detection sensor 304, which is an example conveying abnormality detector for detecting a web P conveying abnormality due, for example, to the jamming of the web P or to an operating error in the web feeding apparatus 300, and for generating a conveying abnormality signal; and a feeding controller 310 that handles a conveying abnormality signal generated by the feeding abnormality detection sensor 304, controls the operation of the web feeding apparatus 300 or communicates with the control computer 600. When the feeding controller 310 receives a conveying abnormality signal from the feeding abnormality detection sensor 304 and identifies a conveying abnormality in the web feeding apparatus 300, the feeding controller 310 notifies the control computer 600 of the occurrence of the conveying abnormality.

With an arrangement that will be described later in detail, the first printer 100A employs image data received from the control computer 600, and prints an image on the obverse face of the web P fed by the web feeding apparatus 300. Furthermore, before printing the image, the first printer 100A prints a registration mark (which will be described later) to prevent an image position shift and misregistration during the printing of an image on the web P.

The first printer 100A also includes a first cutter 801, which is an example cutting unit, located at the web entrance port, for cutting the web P in a direction perpendicular to the web P conveying path; and a second cutter 802, which is an example cutting unit, located at the web discharge port, for cutting the web P, for which image printing by the first printer 100A has been completed, in a direction perpendicular to the conveying path. The first cutter 801 cuts the web P when the web feeding apparatus 300 is halted because of the occurrence of a conveying abnormality, while the second cutter 802 cuts the web P when the web feeding apparatus 300 and the first printer 100A are halted because of the occurrence of a conveying abnormality in the first printer 100A.

When the first printer 100A has printed an image on the obverse face of the web P and is to convey the web P to the second printer 100b, the buffer unit 200 holds a predetermined length of the web P. That is, an upstream roller 201, a tension roller 202 and a downstream roller 203 are arranged as conveying rollers in the buffer unit 200. The tension roller 202 moves vertically (as indicated by arrows), and conveys the web P while maintaining a constant tension thereon through the application of a predetermined force. Thus, while the web P is being conveyed in order, from the upstream roller 201 to the tension roller 202 to the downstream roller 203, a predetermined length of the web P is curved around the tension roller 202, forming a loop in the buffer unit 200. And since within the loop the tension roller 202 moves vertically, in consonance with fluctuations in the force applied to the web P, the occurrence of excessive fluctuations in the tension on the web P is prevented. Further, between the first printer 100A and the second printer 100B, the occurrence of the following phenomenon is prevented: the web P is torn, due to an increase in the tension applied to the web P, or the tension on the web P slackens and shifting, in the direction in which the web P is conveyed, or creasing occurs.

Further, the buffer unit 200 includes: a buffer conveying abnormality detection sensor 204, which is an example conveying abnormality detector that detects an abnormality in the conveying of the web P due, for example, to the jamming of the web P or to an operating error in the buffer unit 200, and generates a conveying abnormality signal; a third cutter 803, which is an example cutting unit, located at the web discharge port, for cutting the web P in a direction perpendicular to the conveying path; and a buffer unit controller 210 that handles a conveying abnormality signal generated by the buffer conveying abnormality detection sensor 204, controls the operation of the third cutter 803 or communicates with the control computer 600. When the buffer unit controller 210 receives a conveying abnormality signal from the buffer conveying abnormality detection sensor 204 and identifies a conveying abnormality in the buffer unit 200, the buffer unit controller 210 notifies the control computer 600 of the occurrence of the conveying abnormality. The third cutter 803 cuts the web P when a conveying abnormality occurs in the buffer unit 200, and the web feeding apparatus 300 and the first printer 100A are halted.

The obverse/reverse side inversion unit 500 inverts the sides of the web P, and supplies the web P to the second printer 100B. The obverse/reverse inversion unit 500 includes an obverse/reverse side inversion roller 501, which is inclined at 45° relative to the direction in which the web P is conveyed. When the web P is extended to the obverse/reverse side roller 501 and is conveyed, the sides of the web P are inverted. Thus, after the web P has passed through the obverse/reverse side inversion unit 500, the direction in which the web P is conveyed is changed 900. Therefore, in direction, the second printer 100B is displaced 900 relative to the first printer 100A.

In addition, the obverse/reverse side inversion unit 500 includes: an inversion conveying abnormality detection sensor 504, which is an example conveying abnormality detector that detects an abnormality in the conveying of the web P due, for example, to the jamming of the web P or to an operating error in the obverse/reverse side inversion unit 500, and generates a conveying abnormality signal; a fourth cutter 804, which is an example cutting unit, located at the web discharge port, for cutting the web P in a direction perpendicular to the conveying path; and an obverse/reverse side inversion unit controller 510 that handles a conveying abnormality signal generated by the inversion conveying abnormality detection sensor 504, controls the operation of the fourth cutter 804 or communicates with the control computer 600. When the obverse/reverse side inversion unit controller 510 receives a conveying abnormality signal from the inversion conveying abnormality detection sensor 504 and identifies a conveying abnormality in the obverse/reverse inversion unit 500, the obverse/reverse side inversion unit controller 510 notifies the control computer 600 of the occurrence of a conveying abnormality. The fourth cutter 804 cuts the web P when a conveying abnormality occurs in the obverse/reverse side inversion unit 500, and the web feeding apparatus 300 and the first printer 100A are halted.

The arrangement of the first printer 100A is also employed for the second printer 100B. After the first printer 100A has printed an image on the obverse face of the web P, the second printer 100B employs image data, received from the control computer 600, and prints an image on the reverse side of the web P.

The second printer 100B also includes a fifth cutter 805, which is an example cutting unit, located at the web discharge port, for cutting the web P, for which image printing by the second printer 100B has been completed, in a direction perpendicular to the conveying path. The fifth cutter 805 cuts the web P when a conveying abnormality occurs in the second printer 100B, and the web feeding apparatus 300, the first printer 100A and the second printer 100B are halted.

The web take-up apparatus 400 winds the web P, the reverse side of which the second printer 100B has completed printing, around a take-up roller 401.

The web apparatus 400 includes: a take-up conveying abnormality detection sensor 404, which is an example conveying abnormality detection sensor that detects an abnormality in the conveying of the web P due, for example, to the jamming of the web P or to an operating error in the web take-up apparatus 400, and generates a conveying abnormality signal; and a take-up controller 410 that handles a conveying abnormality signal generated by the take-up conveying abnormality detection sensor 404, controls the operation of the web take-up apparatus 400 or communicates with the control computer 600. When the take-up controller 410 receives a conveying abnormality signal from the take-up conveying abnormality detection sensor 404, and identifies a conveying abnormality in the web take-up apparatus 400, the take-up controller 410 notifies the control computer 600 of the occurrence of the conveying abnormality.

In the printing system 1 of this embodiment, the first printer 100A forms an image on the obverse side of the web P, and the second printer 100B forms an image on the reverse side. However, the printing system 1 can also be so constructed that the first printer 100A forms an image on the reverse side of the web P, and the second printer 100B forms an image on the obverse side.

At predetermined timings, the control computer 600 respectively outputs to the first printer 100A and the second printer 100B, via the communication network 700, image data to be printed on the obverse face and image data to be printed on the reverse face. The control computer 600 also outputs control signals to control the operations of the first printer 100A and the second printer 100B.

Further, the control computer 600 outputs control signals via the communication network 700 to the web feeding apparatus 300, the buffer unit 200, the obverse/reverse side inversion unit 500 and the web take-up apparatus 400 in order to control the individual operations.

The communication network 700 enables bidirectional communication using a communication line or a cable, and may, for example, be a LAN (a Local Area Network) or a WAN (a Wide Area Network).

In the printing system 1 of this embodiment, the control computer 600 issues a control signal to the first printer 100A to print a full color image on the obverse face of the web P supplied by the web feeding apparatus 300. After the full color image has been printed on the obverse face of the web P, the web P is conveyed to the buffer unit 200. Then, while a predetermined length of the web P is held within the buffer unit 200, the web P is conveyed to the obverse/reverse side inversion unit 500. The web P is inverted, from the obverse face to the reverse face by the obverse/reverse side inversion unit 500, and is then conveyed to the second printer 100B.

The second printer 100B prints a full color image on the reverse face of the web P. Thereafter, the web P, bearing a full color image on both sides, is conveyed to the web take-up apparatus 400 and is wound around the take-up roller 401.

Further, in the printing system 1 of this embodiment, when, due to the jamming of the web P or to an operating error, a web conveying abnormality is detected either in the web feeding apparatus 300, the first printer 100A, the buffer unit 200, the obverse/reverse side inversion unit 500, the second printer 100B or the web take-up apparatus 400, the control computer 600 immediately halts the operation of the apparatus in which the conveying abnormality was detected and of an apparatus or apparatuses located upstream of that apparatus in the web P conveying direction. At the same time, the web P is cut by employing the furthest upstream of the cutters downstream, in the web P conveying direction, of the apparatus in which the conveying abnormality was detected, i.e., the cutter that is located downstream, in the web P conveying direction, that is nearest the apparatus in which the conveying abnormality was detected. The operation of an apparatus or apparatuses located downstream, in the direction in which the web P is conveyed, is halted when the trailing end of the web P that was cut has been collected by the web take-up apparatus 400.

The first printer 100A of this embodiment will now be described.

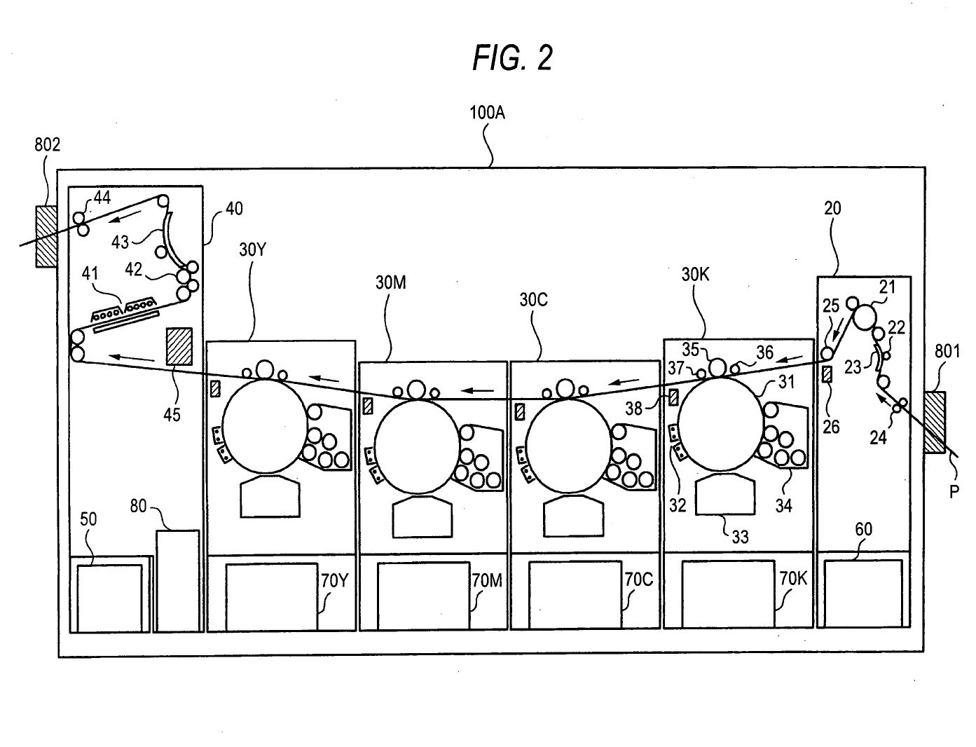

FIG. 2 is a diagram showing the configuration of the first printer 100A of the embodiment. The first printer 100A shown in FIG. 2, for example, is an electrophotographic image forming apparatus, and from upstream, downstream in a direction (indicated by arrows) in which the web P is conveyed, includes: a sheet conveying unit 20, which serves as part of a conveying unit that conveys the web P supplied by the web feeding apparatus 300; four example image forming units, i.e., a K image forming unit 30K, for forming a black (K) toner image on a web P, a C image forming unit 30C, for forming a cyan (C) toner image on the web P, an M image forming unit 30M, for forming a magenta (M) toner image on the web P, and a Y image forming unit 30Y, for forming a yellow (Y) toner image on the web P; and a fixing unit 40, for fixing the individual color toner images formed on the web P.

In addition, the first printer 100A includes: a first cutter 801, which is the first example cutting unit, located at the web entrance port of the sheet conveying unit 20, for cutting the web P in a direction perpendicular to the conveying path; and a second cutter 802, which is the second example cutting unit, located at the web discharge port of the fixing unit 40, for cutting the web P, for which the fixing process performed by the fixing unit 40 has been completed, in a direction perpendicular to the conveying path.

The sheet conveying unit 20, from upstream, downstream in the direction in which the web P is conveyed, includes: a back tension roller 24, an aligning roller 22, a main drive roller 21 and a sheet conveying direction change roller 25.

The main drive roller 21 has as a function the nipping of the web P, under a predetermined pressure, and the conveying of the web P, at a predetermined speed, through the application of a driving force received from a main motor (not shown) that is arranged in the sheet conveying unit 20. The aligning roller 22 is located upstream of the main drive roller 21, and interacts with an arced guide member 23 to maintain a constant path for the conveying of the web P. The back tension roller 24 is located upstream of the main drive roller 21, and by being rotated slower than the main drive roller 21, applies tension to the web P. The sheet conveying direction change roller 25 is a coupled roller, around which the web P is curved, that is rotated by the web P and changes the direction in which the web P is transported, by the main drive roller 21, and guides the web P toward the K image forming unit 30K.

The sheet conveying unit 20 also includes a feeding side conveying abnormality detection sensor 26, which is an example conveying abnormality detector that detects an abnormality, in the conveying of the web P due, for example, to the jamming of the web P or to an operating error in the sheet conveying unit 20, and generates a conveying abnormality signal. When a conveying abnormality for the web P is detected in the sheet conveying unit 20, the feeding side conveying abnormality detection sensor 26 generates and transmits a conveying abnormality signal to a sheet controller 60 (which will be described later) that then transmits the signal to a printer controller 50 (which will also be described later).

The K image forming unit 30K, the C image forming unit 30C, the M image forming unit 30 M and the Y image forming unit 30 Y include: photosensitive drums 31, which serve as image bearing members; charging corotrons 32, for electrifying the surfaces of the photosensitive drums 31 at a predetermined potential; laser exposing devices 33, for exposing the surfaces of the photosensitive drums 31 to light projected based on image data; developing devices 34, for employing toners of individual colors to develop electrostatic latent images formed on the surfaces of the photosensitive drums 31; transfer rollers 35, for transferring, to the web P, the toner images on the surfaces of the photosensitive drums 31; and paired transfer guide rollers 36 and 37, respectively located upstream and downstream of each transfer roller 35, that press the web P against the photosensitive drums 31.

The K image forming unit 30K, the C image forming unit 30C, the M image forming unit 30M and the Y image forming unit 30Y also include image forming unit conveying abnormality detection sensors 38, which are example conveying abnormality detectors that detect an abnormality in the conveying of the web P due, for example, to the jamming of the web P or to an operating error in the individual image forming units, and generate a conveying abnormality signal. When a conveying abnormality for the web P is detected in one of the image forming units, the corresponding image forming unit conveying abnormality detection sensor 38 generates and transmits a conveying abnormality signal to a K color image forming controller 70K, a C image forming controller 70C, an M image forming controller 70M and a Y image forming controller 70Y (all of which will be described later), and these image forming controllers then transmit the conveying abnormality signals to the printer controller 50 (which will also be described later).

The fixing unit 40 includes: a flash fixing unit 41, which is an example fixing processor that employs a light emitting device, such as a flash lamp, to fix the individual color toner images to the web P in a non-contact manner; a tension application roller member 42, which is located downstream of the flash fixing unit 41, for applying tension to the web P; an aligning member 43, which is located downstream of the tension application roller member 42, for correcting the path of the web P in the widthwise direction; and a tension roller 44, which nips the web P near the discharge port and is rotated at a higher circumferential speed than the web P conveying speed to apply tension to the web P.

The fixing unit 40 also includes a discharge side conveying abnormality detection sensor 45, which is an example conveying abnormality detector that detects an abnormality in the conveying the web P due, for example, to the jamming of the web P or to an operating error in the fixing unit 40, and generates a conveying abnormality signal. When a conveying abnormality for the web P is detected in the fixing unit 40, the discharge side conveying abnormality detection sensor 45 generates and transmits a conveying abnormality signal to a fixing controller 80 (which will be described later) that then transmits this signal to the printer controller 50 (which will also be described later).

Furthermore, the first printer 100A includes: the printer controller 50, which controls the entire operation of the first printer 100A; the sheet conveying controller 60, which controls the operation of the sheet conveying unit 20; the K image forming controller 70K, which controls the operation of the K image forming unit 30K; the C image forming controller 70C, which controls the operation of the K image forming unit 30C; the M image forming controller 70M, which controls the operation of the M image forming unit 30M; the Y image forming controller 70Y, which controls the operation of the Y image forming unit 30Y; and a fixing controller 80, which controls the operation of the fixing unit 40.

The sheet conveying controller 60, the K image forming controller 70K, the C image forming controller 70C, the M image forming controller 70M, the Y image forming controller 70Y and the fixing controller 80 are all entirely controlled by the printer controller 50.

When the printing system 1 is activated, the control computer 600 transmits image data via the communication network 700 to the printer controller 50 of the first printer 100A. The printer controller 50 separates the received image data into K, C, M and Y color image data, and transmits the K image data to the K image forming controller 70K, the C image data to the C image forming controller 70C, the M image data to the M image forming controller 70M, and the Y image data to the Y image forming controller 70Y.

Also, synchronized with the reception of image data, the printer controller 50 controls the sheet conveying unit 20, via the sheet conveying controller 60, and controls the fixing unit 40, via the fixing controller 80, so that the web P is conveyed at a predetermined conveying speed by the application of a predetermined tension.

Under the control of the printer controller 50, the K image forming controller 70K, the C image forming controller 70C, the K image forming controller 70M and the Y image forming controller 70Y permit the K image forming unit 30K, the C image forming unit 30c, the M image forming unit 30M and the Y image forming unit 30Y to form individual color toner images.

Specifically, in the K image forming unit 30K, the C image forming unit 30C, the M image forming unit 30M and the Y image forming unit 30Y, the photosensitive drums 31 start to rotate and the charging corotrons 32 electrify the surfaces of the photosensitive drums 31 at a predetermined potential (e.g., −500 V), and the laser exposing devices 33 form electrostatic latent images corresponding to the individual color image data. Then, the developing devices 34 employ the individual color toners to develop the electrostatic latent images on the photosensitive drums 31, and obtain toner images of the individual colors. The thus obtained color toner images on the surfaces of the photosensitive drums 31 are then transferred to the web P by the transfer rolls 35 and the transfer guide rolls 36 and 37. Since the web P is passed through the K image forming unit 30K, the C image forming unit 30C, the M image forming unit 30M and the Y image forming unit 30Y in the named order, the individual color toner images are superimposed in the color order K, C, M and Y, and thereafter, a full color toner image is formed on the web P.

Thereafter, the web P bearing the full color toner image is conveyed to the fixing unit 40, and the flash fixing device 41 fixes the toner image to the web P. As a result, a full color image is formed on the obverse face of the web P.

On the other hand, before the first printer 100A performs the image forming processing, based on image data, a page registration mark (ROF), which is used to align images generated by the first and the second printers 100A and 100B, and color registration marks (ROC), which are used to align color toner images formed by the K image forming unit 30K, the C image forming unit 30C, the M image forming unit 30M and the Y image forming unit 30Y of the first printer 100A, are formed on the web P.

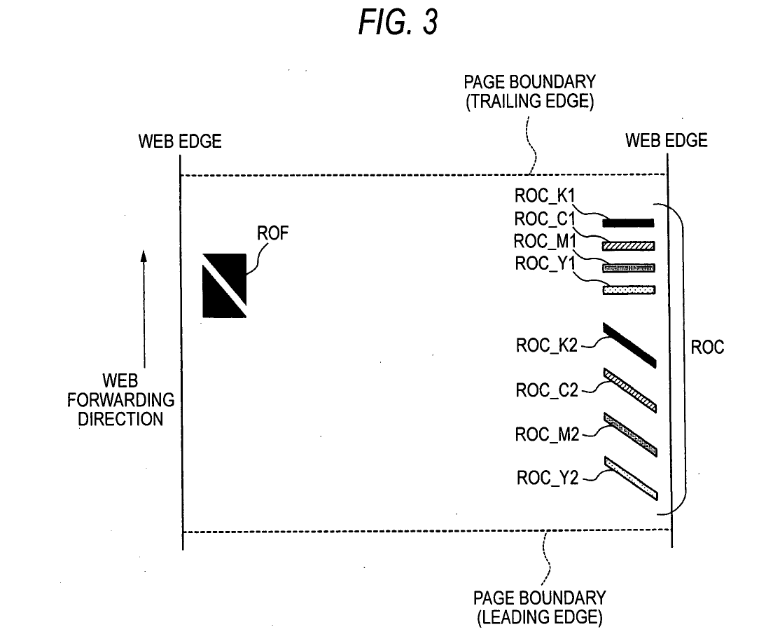

FIG. 3 is a diagram showing an example page registration mark (ROF) and example color registration marks (ROC). The page registration mark (ROF) and the color registration marks (ROC) in FIG. 3 are formed upstream of an image area that is formed based on image data.

In the first printer 100A, an optical sensor (not shown) reads the positions of a K registration mark (ROC_K1) and a C registration mark (ROC_C1) to calculate a distance at which the position of the ROC_C1 is shifted away from that of the ROC_K1 in the sub-scanning direction. Further, the optical sensor (not shown) reads the positions of a K registration mark (ROC_K2) and a C registration mark (ROC_C2) to calculate a distance that the position of the ROC_C2 is shifted away from that of the ROC_K2 in the main scanning direction. Then, the position shift distances in the main scanning direction and in the sub-scanning direction are employed to align a K toner image with a C toner image.

In the same manner, the aligning of a K toner image with an M toner image, and the aligning of a K toner image with a Y toner image are performed, and misregistration or the occurrence of uneven colors in the full color image is prevented.

In the second printer 100B, an optical sensor (not shown) reads the page registration mark (ROF), and detects a page leading edge reference position for a full color image formed by the first printer 100A. Since the second printer 100B employs a detection value and forms a full color image on the reverse face of the web P, misalignment of an image on the obverse face of the web P with an image on the reverse face is prevented.

It should be noted that a line CCD, for example, is employed as an optical sensor that reads a page registration mark (ROF) and color registration marks (ROC).

The process performed by the printing system 1 of this embodiment to convey the web P will now be described.

For the printing system 1 of this embodiment, the control computer 600, the feeding controller 310 of the web feeding apparatus 300, the printer controller 50 (hereinafter referred to as the “first printer controller 50A”) of the first printer 100A, the buffer unit controller 210 of the buffer unit 200, the obverse/reverse side inversion unit controller 510 of the obverse/reverse side inversion unit 500, the printer controller 50 (hereinafter referred to as the “second printer controller 50B”) of the second printer 100B, and the take-up controller 410 of the web take-up apparatus 400 interact to convey the web P.

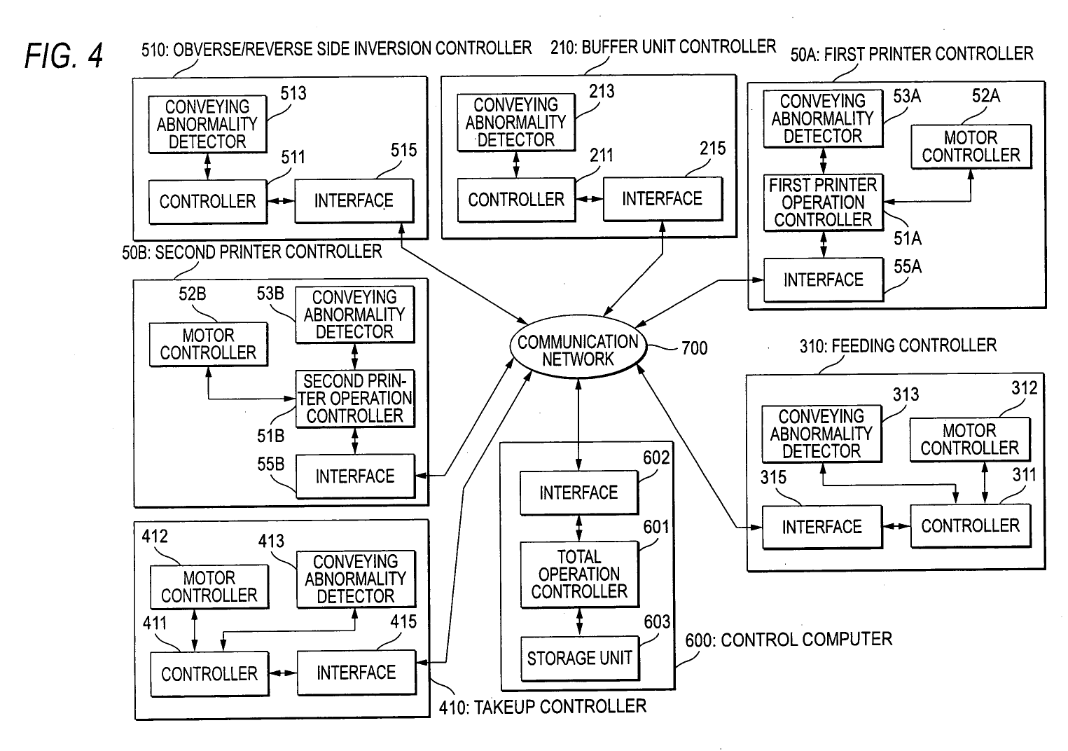

FIG. 4 is a diagram showing the arrangements of the functional sections, related to the conveying processing, of the control computer 600, the feeding controller 310, the first printer controller 50A, the buffer unit controller 210, the obverse/reverse side inversion unit controller 510, the second printer controller 50B and the take-up controller 410.

As shown in FIG. 4, the control computer 600 includes: a total operation controller 601 that totally controls the operations of the web feeding apparatus 300, the first printer 100A, the buffer unit 200, the obverse/reverse side inversion unit 500, the second printer 100B and the web take-up apparatus 400; a storage unit 603 that stores, for example, a control program to be executed by the total operation controller 601; and an interface 602 that controls the transmission/reception of data, relative to the individual controllers, via the communication network 700.

The feeding controller 310 includes: a controller 311 that monitors and controls the overall operation of the web feeding apparatus 300; a motor controller 312 that controls the operation of a drive motor (not shown) for feeding the web P from the web roller 301; a conveying abnormality detector 313 that receives a conveying abnormality signal from the feeding abnormality detection sensor 304 and determines whether a conveying abnormality has occurred in the web feeding apparatus 300; and an interface 315 that controls data transmission/reception, relative to the control computer 600, via the communication network 700.

The first printer controller 50A includes: a first printer operation controller 51A that monitors and controls the operation of the conveying system of the first printer 100A; a motor controller 52A that controls the operation of a main motor (not shown) arranged in the sheet conveying unit 20 of the first printer 100A; a conveying abnormality detector 53A that receives a conveying abnormality signal from the feeding side conveying abnormality detection sensor 26 of the sheet conveying unit 20, the image forming unit conveying abnormality detection sensor 38 for each image forming unit, or the discharge side conveying abnormality detection senor 45 for the fixing unit 40, and determines whether a conveying abnormality has occurred in the first printer 100A; and an interface 55A that controls the transmission/reception of data, relative to the control computer 600, via the communication network 700.

The buffer unit controller 210 includes: a controller 211 that monitors and controls the overall operation of the buffer unit 200; a conveying abnormality detector 213 that receives a conveying abnormality signal from the buffer conveying abnormality detection sensor 204 and determines whether a conveying abnormality has occurred in the buffer unit 200; and an interface 215 that controls the transmission/reception of data, relative to the control computer 600, via the communication network 700.

The obverse/reverse side inversion unit controller 510 includes: a controller 511 that monitors and controls the overall operation of the obverse/reverse side inversion unit 500; a conveying abnormality detector 513 that receives a conveying abnormality signal from the inversion conveying abnormality detection sensor 504 and determines whether a conveying abnormality has occurred in the obverse/reverse side inversion unit 500; and an interface 515 that controls the transmission/reception of data, relative to the control computer 600, via the communication network 700.

The second printer controller 50B includes: a second printer operation controller 51B that monitors and controls the operation of the conveying system of the second printer 100B; a motor controller 52B that controls the operation of a main motor (not shown) arranged in the sheet conveying unit 20 of the second printer 100B; a conveying abnormality detector 53B that receives a conveying abnormality signal from the feeding side conveying abnormality detection sensor 26 of the sheet conveying unit 20, the image forming unit conveying abnormality detection sensor 38 of each image forming unit, or the discharge side conveying abnormality detection sensor 45 of the fixing unit 40, and determines whether a conveying abnormality has occurred in the second printer 100B; and an interface 55B that controls the transmission/reception of data, relative to the control computer 600, via the communication network 700.

The take-up controller 410 includes: a controller 411 that monitors and controls the overall operation of the web take-up apparatus 400; a motor controller 412 that controls the operation of a drive motor (not shown) that winds the web P around the take-up roller 401; a conveying abnormality detector 413 that receives a conveying abnormality signal from the take-up conveying abnormality detection sensor 404 and determines whether a conveying abnormality has occurred in the web take-up apparatus 400; and an interface 415 that controls the transmission/reception of data, relative to the control computer 600, via the communication network 700.

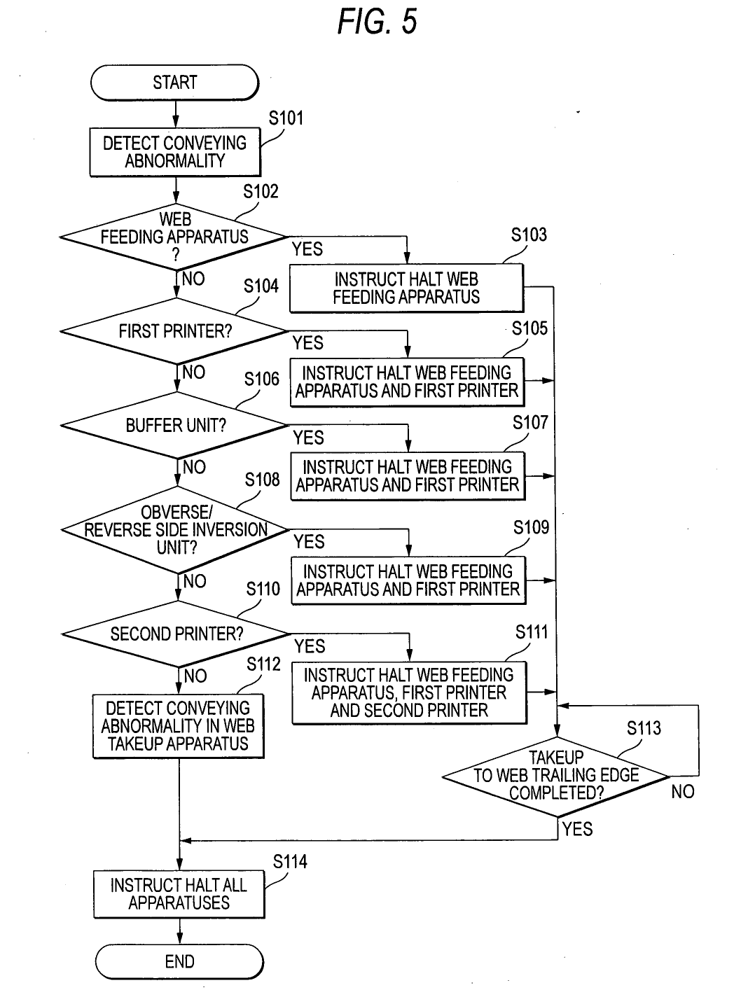

FIG. 5 is a flowchart showing example web conveying processing performed by the printing system 1 of this embodiment. According to the printing system 1 of this embodiment, the total operation controller 601 of the control computer 600 controls the entire conveying operation using the individual apparatuses.

As shown in FIG. 5, when a conveying abnormality is detected in one of apparatuses (S101), the total operation controller 601 of the control computer 600 identifies the apparatus in which the conveying abnormality occurred. When the total operation controller 601 determines that the conveying abnormality has been detected by the conveying abnormality detector 313 of the feeding controller 310 (S102), the total operation controller 601 issues an instruction to the controller 311 of the feeding controller 310 to halt the web feeding apparatus 300 (S103). Thus, the motor controller 312 of the feeding controller 310 halts the drive motor (not shown).

In this case, all the apparatuses located downstream of the web feeding apparatus 300 in the web conveying direction, i.e., the first printer 100A, the buffer unit 200, the obverse/reverse side inversion unit 500, the second printer 100B and the web take-up apparatus 400 continue the conveying operation. Therefore, between the web take-up apparatus 400 and the first printer 100A, the amount the web P is bent is reduced, and the tension on the web P is increased. As a result, the first cutter 801, located at the web entrance port of the sheet conveying unit 20 of the first printer 100A, cuts the web P in a direction substantially perpendicular to the conveying direction, as will be described later.

The web P cut by the first cutter 801 is taken up around the take-up roller 401 by the web take-up apparatus 400, and when the take-up controller 410 detects that the trailing edge of the web P has reached the take-up roller 401 and the winding has been completed (S113), the total operation controller 601 of the control computer 600 issues an instruction to halt the entire printing system 1 (S114).

When the total operation controller 601 determines that a conveying abnormality has been detected by the conveying abnormality detector 53A of the first printer 100A (S104), the total operation controller 601 issues an instruction to the controller 311 of the feeding controller 310 and the first printer operation controller 51A of the first printer 100A to halt the web feeding apparatus 300 and the first printer 100A (S105). Thus, the motor controller 312 of the feeding controller 310 and the motor controller 52A of the first printer controller 50A stop their drive motors (not shown).

In this case, the apparatuses located downstream of the first printer 100A in the web conveying direction, i.e., the buffer unit 200, the obverse/reverse side inversion unit 500, the second printer 100B and the web take-up apparatus 400 continue, the conveying operation. Therefore, between the first printer 100A and the buffer unit 200, the amount the web P is bent is reduced, and the tension on the web P is increased. As a result, the second cutter 802, located at the web discharge port of the fixing unit 40 of the first printer 100A, cuts the web P in a direction substantially perpendicular to the conveying direction.

The web P cut by the second cutter 802 is taken up around the take-up roller 401 by the web take-up apparatus 400, and when the take-up controller 410 detects that the trailing edge of the web P has reached the take-up roller 401 and winding has been completed (S113), the total operation controller 601 of the control computer 600 issues an instruction to halt the entire printing system 1 (S114).

When the total operation controller 601 determines that a conveying abnormality has been detected by the conveying abnormality detector 213 of the buffer unit 200 (S106), the total operation controller 601 issues a control signal to the controller 311 of the feeding controller 310 and the first printer operation controller 51A of the first printer controller 50A to halt the web feeding apparatus 300 and the first printer 100A (S107). Thus, the motor controller 312 of the feeding controller 310 and the motor controller 52A of the first printer controller 50A stop their drive motors (not shown).

In this case, the apparatuses located downstream of the buffer unit 200 in the web conveying direction, i.e., the obverse/reverse side inversion unit 500, the second printer 100B and the web take-up apparatus 400, continue the conveying operation. And thus, between the buffer unit 200 and the obverse/reverse side inversion unit 500, the amount the web P is bent is reduced, and the tension on the web P is increased. As a result, the third cutter 803, located at the web discharge port of the buffer unit 200, cuts the web P in a direction substantially perpendicular to the conveying direction.

The web P cut by the third cutter 803 is taken up around the take-up roller 401 by the web take-up apparatus 400, and when the take-up controller 410 detects that the trailing edge of the web P has reached the take-up roller 401 and the winding has been completed (S113), the total operation controller 601 of the control computer 600 issues a control signal to halt the entire printing system 1 (S114).

When the total operation controller 601 determines that a conveying abnormality has been detected by the conveying abnormality detector 513 of the obverse/reverse side inversion unit 500 (S108), the total operation controller 601 issues a control signal to the controller 311 of the feeding controller 310 and the first printer operation controller 51A of the first printer controller 50A to halt the web feeding apparatus 300 and the first printer 100A (S109). Thus, the motor controller 312 of the feeding controller 310 and the motor controller 52A of the first printer controller 50A stop their drive motors (not shown).

In this case, the apparatuses located downstream of the obverse/reverse side inversion unit 500 in the web conveying direction, i.e., the second printer 100B and the web take-up apparatus 400 continue the conveying operation. And between the obverse/reverse side inversion unit 500 and the second printer 100B, the amount the web P is bent is reduced and the tension on the web P is increased. As a result, the fourth cutter 804, located at the web discharge port of the obverse/reverse side inversion unit 500, cuts the web P in a direction substantially perpendicular to the conveying direction.

The web P cut by the fourth cutter 804 is taken up around the take-up roller 401 by the web take-up apparatus 400, and when the take-up controller 410 detects that the trailing edge of the web P has reached the take-up roller 401 and the winding has been completed (S113), the total operation controller 601 of the control computer 600 issues a control signal to halt the entire printing system 1 (S114).

When the total operation controller 601 determines that a conveying abnormality has been detected by the conveying abnormality detector 53B of the second printer 100B (S110), the total operation controller 601 issues a control signal to the controller 311 of the feeding controller 310, the first printer operation controller 51A of the first printer controller 50A and the second printer operation controller 51B of the second printer controller 50B to halt the web feeding apparatus 300, the first printer 100A and the second printer 100B (S111). Thus, the motor controller 312 of the feeding controller 310, the motor controller 52A of the first printer controller 50A and the motor controller 52B of the second printer controller 50B stop their drive motors (not shown).

In this case, the apparatus located downstream of the second printer 100B in the web conveying direction, i.e., the web take-up apparatus 400, continues the conveying operation. Thus, between the second printer 100B and the web take-up apparatus 400, the amount the web P is bent is reduced, and the tension on the web P is increased. As a result, the fifth cutter 805, located at the web discharge port of the fixing unit 40 of the second printer 100B, cuts the web P in a direction substantially perpendicular to the conveying direction.

The web P cut by the fifth cutter 805 is taken up around the take-up roller 401 by the web take-up apparatus 400, and when the take-up controller 410 detects that the trailing edge of the web P has reached the take-up roller 401 and the winding has been completed (S113), the total operation controller 601 of the control computer 600 issues a control signal to halt the entire printing system 1 (S114).

When the total operation controller 601 determines that a conveying abnormality has been detected by the conveying abnormality detector 413 of the web take-up apparatus 400 (S112), the total operation controller 601 issues a control signal to stop all the apparatuses (S114).

As described above, in the printing system 1 of this embodiment, when a web conveying abnormality due to the jamming of the web P or an operating error is detected in one of the web feeding apparatus 300, the first printer 100A, the buffer unit 200, the obverse/reverse side inversion unit 500, the second printer 100B or the web take-up apparatus 400, the control computer 600 halts the operation of the apparatus in which the conveying abnormality is detected and apparatuses that are located upstream of this apparatus in the web conveying direction. At the same time, the web P is cut by using the cutter that is the furthest upstream of the cutters located downstream, in the web P conveying direction, of the apparatus for which the conveying abnormality is detected. That is, the web P is cut by using a cutter that is located the nearest, and downstream, in the conveying direction, of the apparatus for which the conveying abnormality is detected. The operation of an apparatus that is located downstream, in the conveying direction, of the apparatus in which the conveying abnormality is detected is halted when the trailing edge of the cut web P has been collected by the web take-up apparatus 400.

As described above, the image forming operation is maintained for the portion of the web P that already was passed through the apparatus in which the conveying abnormality was detected and that is downstream of this apparatus. Thus, the amount the web P that is wasted, i.e., a so-called “paper loss”, is reduced. Further, since an unfixed image is not present on the side downstream of the apparatus in which the conveying abnormality was detected, defacing occurring inside the apparatus can be prevented. And in addition, since none of the web P remains in a printing system 1 apparatus downstream of the one in which the conveying abnormality was detected, for a recovery operation, the number of steps an operator is required to perform is reduced.

The second cutter 802 may be located at the web entrance port of the buffer unit 200, the third cutter 803 may be located at the web entrance port of the obverse/reverse side inversion unit 500, and the fourth cutter 804 may be located at the web entrance port of the second printer 100B. However, to reduce paper loss, it is more effective for the cutters to be individually arranged upstream, nearer preceding apparatuses.

The cutters that cut the web P perpendicular to the conveying direction will now be described.

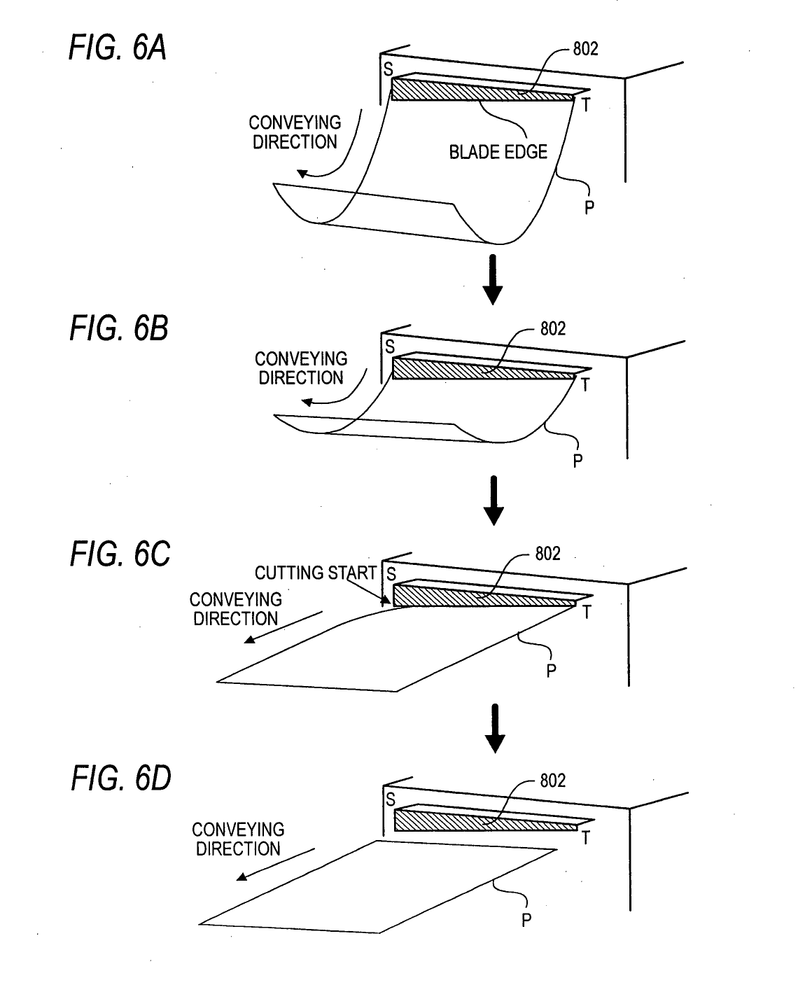

FIGS. 6A to 6D are diagrams depicting a process during which a cutter cuts the web P in a direction substantially perpendicular to the conveying direction. For this explanation, given while referring to FIGS. 6A to 6D, the second cutter 802, located at the discharge port of the sheet conveying unit 20 of the first printer 100A, is employed as an example cutter.

First, as shown in FIG. 6A, while the operating condition is normal and the web P is being conveyed by the first printer 100A and other apparatuses downstream, a predetermined slackness in the web P is maintained between the first printer 100A and the buffer unit 200. Thus, in this state, the web P does not touch the edge (the face) of the blade of the first cutter 801 and is not cut.

The predetermined slackness in the web P is provided and maintained between the members of each pair of adjacent apparatus sides, while taking into consideration slight differences in the start timings and in the accelerations of the individual apparatuses. And in the printing system 1 of this embodiment, the predetermined slackness is obtained for each pair at the time the apparatuses begin to convey the web P.

Thereafter, in a state wherein the web feeding apparatus 300 and the first printer 100A are halted because of the occurrence of a conveying abnormality in the first printer 100A, and the apparatuses located downstream of the first printer 100A, i.e., the buffer unit 200, the obverse/reverse side inversion unit 200, the second printer 100B and the web take-up apparatus 400, continue the conveying operation, as shown in FIG. 6B, the bend in the web P, between the first printer 100A and the buffer unit 200, is gradually reduced, until the web P is brought into contact with the blade edge of the second cutter 802.

Then, while tension is applied to the web P and it is stretched tautly and pressed tightly against the blade edge of the second cutter 802, as shown in FIG. 6C, the blade edge of the second cutter 802, which in the conveying direction is extended downward on one side (side S in FIG. 6) and gradually slopes upward as it nears the other side (side T in FIG. 6), begins to cut the web P at side S. Progressively, as shown in FIG. 6D, the cutting of the web P continues until, on side T, the downstream portion of the web P has been severed, by the second cutter 802, from the upstream portion in the printer 100A, and henceforth continues to be conveyed downstream. The upstream end portion of the web P, on the other hand, remains in the printer 100A.

In this case, as shown in FIGS. 6A to 6D, since the blade edge of the second cutter 802 is obliquely arranged relative to the direction in which the web P is brought into contact with it, the cutting stress is concentrated at the location of the cut in the web P, and the downstream portion can be severed evenly. Thus, since the cut plane of the web P is linear, the usable web P area is increased. And furthermore, the operator can easily adjust the web P to perform a recovery process for the printing system 1.

Furthermore, the blade edge of the second cutter 802 can also be arranged obliquely relative to the conveying direction, so that the location (side S) at which the cutting of the web P is started is downstream in the conveying direction, and the location (side T) at which the cutting is completed is upstream in the conveying direction. Thus, the location at which the web P, which is being conveyed, is cut, can be aligned in a direction perpendicular to the conveying direction.

In addition, when the width of the second cutter 802 is greater than that of the web P, the web P can be evenly cut, beginning at the end of the web P.

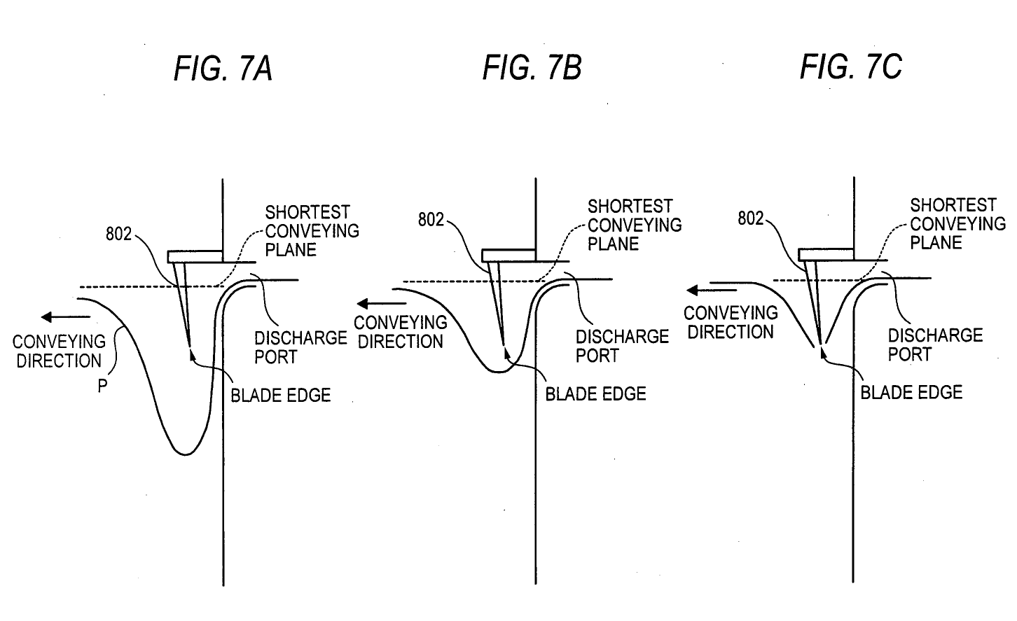

FIGS. 7A to 7C are diagrams for explaining the position of the blade edge of a cutter, for which the second cutter 802 is also employed as an example.

As shown in FIGS. 7A to 7C, the blade edge of the second cutter 802 extends below the plane (the shortest conveying plane) connecting the web discharge port of the apparatus (the first printer 100A), where the second cutter 802 is located, to the web entrance port of the downstream apparatus (the buffer unit 200), and above the position at which, in the normal state, the web P is conveyed from the apparatus (the first printer 100A), where the second cutter 802 is located, to the downstream apparatus (the buffer unit 200), while a predetermined bend is maintained in the web P. Therefore, when the web P is conveyed in the normal state (FIG. 7A), the web P does not touch the blade edge of the second cutter 802, which permits the web P to be conveyed without being cut (see FIG. 6A).

When a conveying abnormality occurs in the apparatus (the first printer 100A) whereat the second cutter 802 is located, the apparatus (the first printer 100A) whereat the second cutter 802 is located and the other apparatus located upstream are halted, while the apparatuses located downstream of the apparatus (the first printer 100A) whereat the second cutter 802 is located continue the conveying operation. In this state, the slackness in the portion of the web P being conveyed from the apparatus (the first printer 100A) where the second cutter 802 is located to the downstream apparatus (the buffer unit 200) is gradually taken up, and the web P conveying path is moved upward toward the shortest conveying plane (FIG. 7B). Then, as the web P is raised and is brought into contact with the blade edge of the second cutter 802, which is positioned below the shortest conveying plane (FIG. 7C), the cutting of the web P is begun (see FIG. 6C) and is continued until the downstream portion of the web P is severed from the upstream (see FIG. 6D).

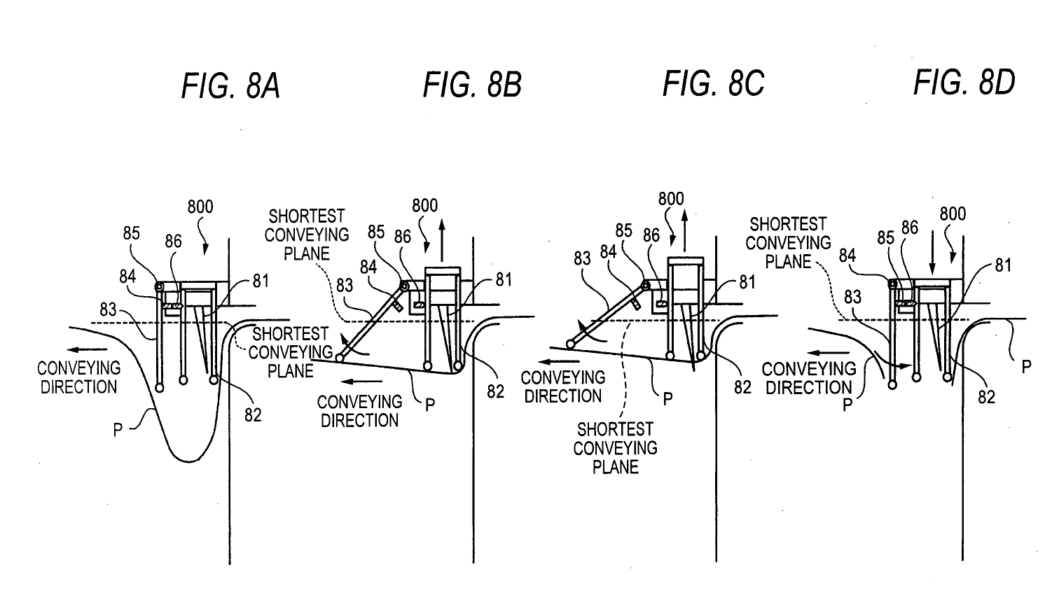

FIGS. 8A to 8D are diagrams showing the structure of a cutter 800 that includes a safety mechanism for protecting an operator from being accidentally cut. This cutter 800 can be employed for one or a plurality of cutters, from the first cutter 801 through the fifth cutter 805, and is especially effective when mounted externally.

The cutter 800 of this embodiment includes: a cutter portion 81, for cutting the web P in a direction almost perpendicular to the conveying path; a protective cover 82, for covering the cutter portion 81, that can be moved vertically along the cutter portion 81; a stopper 86, for holding the protective cover 82; a lever 83, which pivots at a hinge 85; and a stopper unlock pin 84, which is integrally formed with the lever 83 and which moves the stopper 86 to a position whereat the protective cover 82 is locked in place and to a position whereat the protective cover 82 is movable, in synchronization with the pivoting of the lever 83.

As in the structure explained while referring to FIG. 7, the blade edge of the cutter portion 81 is located below the shortest conveying plane, and above a position at which the web P is conveyed in the normal state while the predetermined slackness in the web P is maintained.

In the normal state of this embodiment (FIG. 8A), wherein the web P is being conveyed, the protective cover 82 of the cutter 800 is positioned and held by the stopper 86 so that the blade edge of the cutter portion 81 is covered. Thus, the blade edge of the cutter portion 81 is prevented from contacting the web P, and an operator is also protected from touching the blade edge of the cutter portion 81. To maintain this state, the lever 83 is held vertical, by its weight, and inserts the stopper unlocking pin 84 so that it engages the stopper 86 and prevents the upward displacement of the protective cover 82.

When a conveying abnormality occurs in the apparatus whereat the cutter 800 is arranged, and the bend in the web P is gradually reduced, the web conveying path is moved upward toward the shortest conveying plane (FIG. 8B), the lever 83, pivoting at the hinge 85, is lifted as the web P is moved, and accordingly, the stopper unlock pin 84 is withdrawn, permitting the stopper 86 to move to a position at which the protective cover 82 can be lifted. Thus, the protective cover 82 is rendered movable, and as the web conveying path is raised, toward the shortest conveying path, the web P lifts the protective cover 82 vertically.

As the web conveying path nears the shortest conveying plane (FIG. 8C), the protective cover 82 is lifted until the blade edge of the cutter portion 81 is exposed and contacts the web P. Thereafter, the web P is cut in a direction substantially perpendicular to the conveying direction.

After the web P has been cut (FIG. 8D), the lever 83, which was lifted by the web P, is pivoted downward by its own weight and is returned to its original, vertical position. Accordingly, the stopper unlock pin 84 impels the stopper 86 to the position whereat the protective cover 82 is immobilized, while at the same time, the weight of the protective cover 82 returns the protective cover 82 to its original position.

As described above, in this embodiment, during a normal situation wherein the web P is being conveyed, the blade edge of the cutter portion 81 of the cutter 800 is covered by the protective cover 82. Upon the occurrence of a conveying abnormality, however, the blade edge of the cutter portion 81 is exposed by the protective cover 82, and cuts the web P in a direction almost perpendicular to the conveying direction. With this arrangement, the blade edge of the cutter portion 81 is prevented from contacting the web P unnecessarily, and the operator is protected, and prevented from touching the blade edge.

For the printing system 1 of this embodiment, a cutter is employed as an example cutting unit for cutting the web P in a direction perpendicular to the conveying path. However, for a printing system that employs a web P in which perforations are formed, in line, across the width of the web P, a cutting unit may be a mechanism that presses down along the perforations to sever a portion of the web P perpendicular to the conveying path.

As described above, according to the printing system 1 of the embodiment, when a web conveying abnormality due to the jamming of the web P or an operating error is detected in one of the web feeding apparatuses 300, the first printer 100A, the buffer unit 200, the obverse/reverse side inversion unit 500, the second printer 100B and the web take-up apparatus 400, the control computer 600 immediately halts the apparatus at the location whereat the conveying abnormality was detected and all apparatuses located upstream of that apparatus in the conveying direction. At the same time, the web P is cut using the uppermost cutter that is located downstream, in the conveying direction, of the apparatus whereat the conveying abnormality was detected, i.e., the cutter that is located downstream, in the conveying direction, nearest the apparatus whereat the conveying abnormality was detected. The operation of an apparatus located downstream, in the conveying direction, of the apparatus whereat the conveying abnormality was detected is halted when the trailing cut edge of the web P has been collected.

Through this processing, since the image forming operation continues to be performed for the portion of the web P that has already passed through the apparatus whereat the conveying abnormality was detected, and is present downstream of this apparatus, the amount of the web P that is wasted is reduced. Further, since an unfixed image is not present on the side downstream of the apparatus at which the conveying abnormality was detected, image defacing inside the apparatus can be prevented. In addition, since the web P does not remain downstream of the apparatus at which the conveying abnormality was detected, for the printing system 1, the number of steps required of an operator to perform a recovery operation is reduced

### Second Embodiment

The configuration wherein the first printer 100A and the second printer 100B that are arranged to form a full color image on both sides of the web P has been described for the printing system 1 of the first embodiment. For a printing system 2 of a second embodiment, an explanation will be given for a configuration wherein four printers that form color toner images, are respectively arranged to provide a full color image on one side of a web P. In the second embodiment, the same reference numerals as used in the first embodiment are employed to denote corresponding components, and no detailed explanation for them will be given.

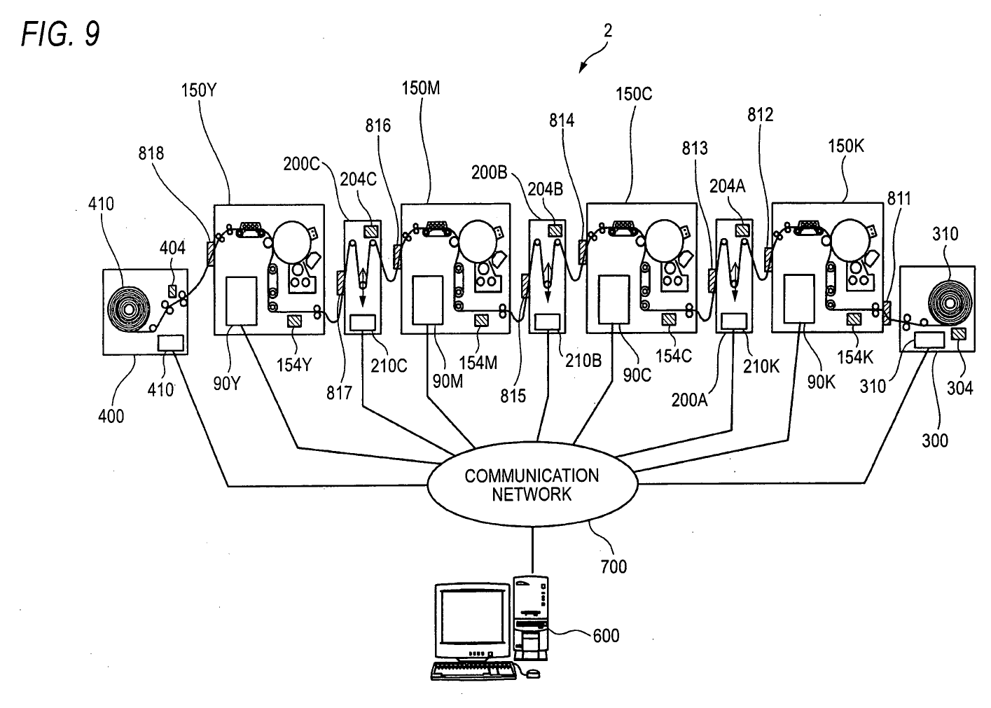

FIG. 9 is a diagram showing the general configuration of the printing system 2 of this embodiment. In the printing system 2 in FIG. 9, four so-called web-fed printing presses that form individual color images on one side of a web P are coupled as image forming apparatuses. That is, the printing system 2 of this embodiment comprises, from upstream to downstream in a direction in which the web P is conveyed: a web feeding apparatus 300; a K color printer 150K, which is an example image forming unit that forms a black (K) toner image on the web P; a first buffer unit 200A, which is an example medium conveying unit; a C color printer 150C, which is an example image forming unit that forms a cyan (C) toner image on the web P; a second buffer unit 200B, which is example medium conveying unit; an M color printer 150M, which an example image forming unit that forms a magenta (M) toner image on the web P; a third buffer unit 200C, which is an example medium conveying unit; a Y color printer 150Y, which is an example image forming unit that forms a yellow (Y) toner image on the web P; and a web take-up apparatus 400.

The printing system 2 of this embodiment also comprises a control computer 600 that serves as an example control unit (a control apparatus) that controls the operation of each of the individual apparatuses of the printing system 2. The control computer 600 is connected, via a communication network 700, which is an example communication device, to the web feeding apparatus 300, the K color printer 150K, the first buffer unit 200A, the C color printer 150C, the second buffer unit 200B, the M color printer 150M, the third buffer unit 200C, the Y color printer 150Y and the web take-up apparatus 400.

The web feeding apparatus 300 includes: a feeding abnormality detection sensor 304, which that is an example conveying abnormality detector for detecting a conveying abnormality, due to jamming of the web P in the web feeding apparatus 300 or an operating error, and for generating a conveying abnormality signal; and a feeding controller 310 that handles a conveying abnormality signal generated by the feeding abnormality detection sensor 304, controls the operation of the web feeding apparatus 300, or communicates with the control computer 600. When the feeding controller 310 receives a conveying abnormality signal from the feeding abnormality detection sensor 304 and identifies the conveying abnormality in the web feeding apparatus 300, the feeding controller 310 notifies the control computer 600 of the occurrence of the conveying abnormality.

The first buffer unit 200A includes: a first buffer conveying abnormality detection sensor 204A, which is an example conveying abnormality detector for detecting a conveying abnormality due to jamming of the web P in the first buffer unit 200A or an operating error and for generating a conveying abnormality signal; a third cutter 813, which is an example cutting unit located at the web discharge port to cut the web P in a direction perpendicular to the conveying path; and a first buffer unit controller 210A, which handles a conveying abnormality signal generated by the first buffer conveying abnormality detection sensor 204A, controls the operation of the third cutter 813, or communicates with the control computer 600. When the first buffer unit controller 210A receives a conveying abnormality signal from the first buffer conveying abnormality detection sensor 204A and identifies the conveying abnormality in the first buffer unit 200A, the first buffer unit controller 210A notifies the control computer 600 of the occurrence of the conveying abnormality, while the third cutter 813 cuts the web P when the web feeding apparatus 300 and the K color printer 150K are halted because of the occurrence of the conveying abnormality in the first buffer unit 200A.

The second buffer unit 200B includes: a second buffer conveying abnormality detection sensor 204B, which is an example conveying abnormality detector for detecting a conveying abnormality due to jamming of the web P in the second buffer unit 200B or an operating error and for generating a conveying abnormality signal; a fifth cutter 815, which is an example cutting unit that is located at the web discharge port to cut the web P in a direction perpendicular to the conveying path; and a second buffer unit controller 210B that handles a conveying abnormality signal generated by the second buffer conveying abnormality detection sensor 204B, controls the operation of the fifth cutter 815, or communicates with the control computer 600. When the second buffer unit controller 210B receives the conveying abnormality signal from the second buffer conveying abnormality detection sensor 204B and identifies the conveying abnormality in the second buffer unit 200B, the second buffer unit controller 210B notifies the control computer 600 of the occurrence of the conveying abnormality, while the fifth cutter 815 cuts the web P when the web feeding apparatus 300, the K color printer 150K and the C color printer 150C are halted because of the occurrence of the conveying abnormality in the second buffer unit 200B.

The third buffer unit 200C includes: a third buffer conveying abnormality detection sensor 204C, which is an example conveying abnormality detector for detecting a conveying abnormality due to jamming of the web P in the third buffer unit 200C or an operating error and for generating a conveying abnormality signal; a seventh cutter 817, which is an example cutting unit that is located at the web discharge port to cut the web P in a direction perpendicular to the conveying path; and a third buffer unit controller 210C, which handles a conveying abnormality signal generated by the third buffer conveying abnormality detection sensor 204C, controls the operation of the seventh cutter 817, or performs communication with the control computer 600. When the third buffer unit controller 210C receives the conveying abnormality signal from the third buffer conveying abnormality detection sensor 204C and identifies the conveying abnormality in the third buffer unit 200C, the third buffer unit controller 210C notifies the control computer 600 of the occurrence of the conveying abnormality, while the seventh cutter 817 cuts the web P when the web feeding apparatus 300, the K color printer 150K, the C color printer 150C and the M color printer 150M are halted because of the occurrence of the conveying abnormality in the third buffer unit 200C.

The web take-up apparatus 400 includes: a take-up conveying abnormality detection sensor 404, which is an example conveying abnormality detector for detecting a conveying abnormality due to jamming of the web P in the web take-up apparatus 400 or an operating error and for generating a conveying abnormality signal; and a take-up controller 410, which handles a conveying abnormality signal generated by the take-up conveying abnormality detection sensor 404, controls the operation of the web take-up apparatus 400, or communicates with the control computer 600. When the take-up controller 410 receives the conveying abnormality signal from the take-up conveying abnormality detection sensor 404 and identifies the conveying abnormality in the web take-up apparatus 400, the take-up controller 410 notifies the control computer 600 of the occurrence of the conveying abnormality.

The K color printer 150K of this embodiment will now be described.

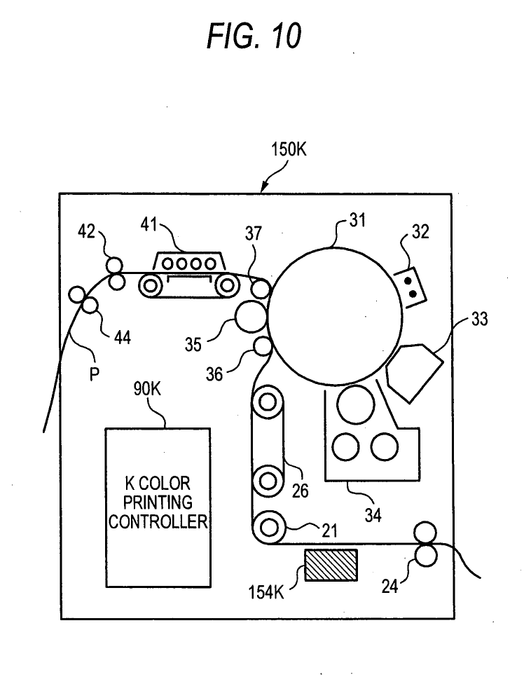

FIG. 10 is a diagram showing the arrangement of the K color printer 150K of the second embodiment. The K color printer 150K in FIG. 10 is, for example, an electrophotographic image forming apparatus, and includes: a photosensitive drum 31, which is an image bearing member; a charging corotron 32, which electrifies the surface of the photosensitive drum 31 at a predetermined potential; a laser exposing device 33, which exposes the surface of the photosensitive drum 31 to light projected based on image data; a developing device 34, which employs a K color toner to develop an electrostatic latent image formed on the surface of the photosensitive drum 31; a transfer roller 35, which transfers, to the web P, a toner image formed on the surface of the photosensitive drum 31; a pair of transfer guide rollers 36 and 37, which are respectively located upstream and downstream of the transfer roller 35 for pressing the web P against the photosensitive drum 31; and a flash fixing device 41, which performs flash fixing of the toner image formed on the web P.

Further, the K color printer 150K includes a K color printer conveying abnormality detection sensor 154K, which is an example conveying abnormality detector that detects a conveying abnormality due to jamming of the web P in the K color printer 150K or an operating error, and generates a conveying abnormality signal.

As a conveying system, the K color printer 150K includes back tension rollers 24, a main drive roller 21, which is driven by a main motor (not shown), and a conveying belt member 26. Further, as a discharge system, the K color printer 150K includes tension application rollers 42, which apply tension to the web P; and tension rollers 44, which are rotated at a circumferential velocity higher than the speed at which the web P is conveyed and which apply tension to the web P.

In addition, the K color printer 150K includes a K color printing controller 90K for controlling the entire operation of the K color printer 150K.

Moreover, the K color printer 150K includes: a first cutter 811, which is an example cutting unit that is located at the web entrance port to cut the web P in a direction perpendicular to the conveying path; and a second cutter 812, which is an example cutting unit that is located at the web discharge port to cut, in a direction perpendicular to the conveying path, the web P for which the image printing by the K color printer 150K has been completed. The first cutter 811 cuts the web P when the web feeding apparatus 300 is halted because of the occurrence of a conveying abnormality in the web feeding apparatus 300. The second cutter 812 cuts the web P when a conveying abnormality has occurred in the K color printer 150K and the web feeding apparatus 300 and the K color printer 150K are halted.

Substantially the same arrangement is employed for the C color printer 150C, the M color printer 150M and the Y color printer 150Y, except that as example cutting units that cut the web P perpendicular to the conveying direction, a fourth cutter 814, a sixth cutter 816 and an eighth cutter 818 are respectively located at the web discharge ports of the C color printer 150C, the M color printer 150M and the Y color printer 150Y.

When a conveying abnormality occurs in one of the C color printer 150C, the M color printer 150M or the Y color printer 150Y, and when the C color printer 150C, the M color printer 150M or the Y color printer 150Y and apparatuses located upstream are halted, the fourth cutter 814, the sixth cutter 816 or the eighth cutter 818 cuts the web P for which image printing by the C color printer 150C, the M color printer 150M or the Y color printer 150Y has been completed.

The C color printer 150C includes a C color printing controller 90C for controlling the entire operation of the C color printer 150C; the M color printer 150M includes an M color printing controller 90M for controlling the entire operation of the M color printer 150M; and the Y color printer 150Y includes a Y color printing controller 90Y for controlling the entire operation of the Y color printer 150Y. These controllers are connected to the control computer 600 via the communication network 700.

In this embodiment, when instructed by the respectively arranged printing controllers, the color printers (the K color printer 150K, the C color printer 150C, the M color printer 150M and the Y color printer 150Y) print corresponding color images on the web P supplied by the web feeding apparatus 300.

Specifically, when the printing system 2 of this embodiment is activated, first, the control computer 600 transmits K color image data for the K color printing controller 90K of the K color printer 150K via the communication network 700. In synchronization with the transmission of the K color image data to the K color printing controller 90K, conveying of the web P, at a predetermined speed, is initiated, and rotation of the photosensitive drum 31 is begun. The charging corotron 32 electrifies the surface of the photosensitive drum 31 at a predetermined potential, such as −500 V, and the laser exposing device 33 forms thereon an electrostatic latent image consonant with the K color image data. Then, the developing device 34 develops the electrostatic latent image on the photosensitive drum 31 using K color toner, and obtains a K toner image. Thereafter, the K color toner image formed on the surface of the photosensitive drum 31 is transferred to the web P by the transfer roller 35 and the transfer guide rollers 36 and 37, and as a result, the K color toner image is formed on the web P.

Thereafter, the flash fixing device 41 fixes the K toner image to the web P, and the K color image is completed.

The web P, on which the K color image is printed by the K color printer 150K, is conveyed to the first buffer unit 200A. Then, while a predetermined slackness in the web P is retained inside the first buffer unit 200A, the web P is conveyed to the C color printer 150C.

The C color printer 150C performs the same processing for printing a C color image on the web P that is fed from the first buffer unit 200A. After the C color printer 150C has printed the C color image by superimposing it on the K color image, the C color printer 150C conveys the web P to the second buffer unit 200B. Thereafter, the second buffer unit 200B conveys the web P to the M color printer 150M, while retaining a predetermined slackness in the web P.

The M color printer 150M performs the same processing to print an M color image on the web P that is received from the second buffer unit 200B. After the M color printer 150M has printed the M color image by superimposing it on the K and C color images, the M color printer 150M conveys the web P to the third buffer unit 200C. Thereafter, the third buffer unit 200C conveys the web P to the Y color printer 150Y, while retaining a predetermined slackness in the web P.

The Y color printer 150Y performs the same processing to print a Y color image on the web P that is received from the third buffer unit 200C. After the Y color printer 150Y has printed the Y color image by superimposing it on the K, C and Y color images, and has thus completed a full color image, the Y color printer 150Y conveys the web P to the web take-up apparatus 400, which winds the web P around a take-up roll 401.

Before forming the K color image, the K color printer 150 forms, on the web P, a page registration mark (see FIG. 3) that is used as a position reference for image forming. The C color printer 150C, the M color printer 150M and the Y color printer 150Y employ the page registration mark to form the C color image, the M color image and the Y color image.

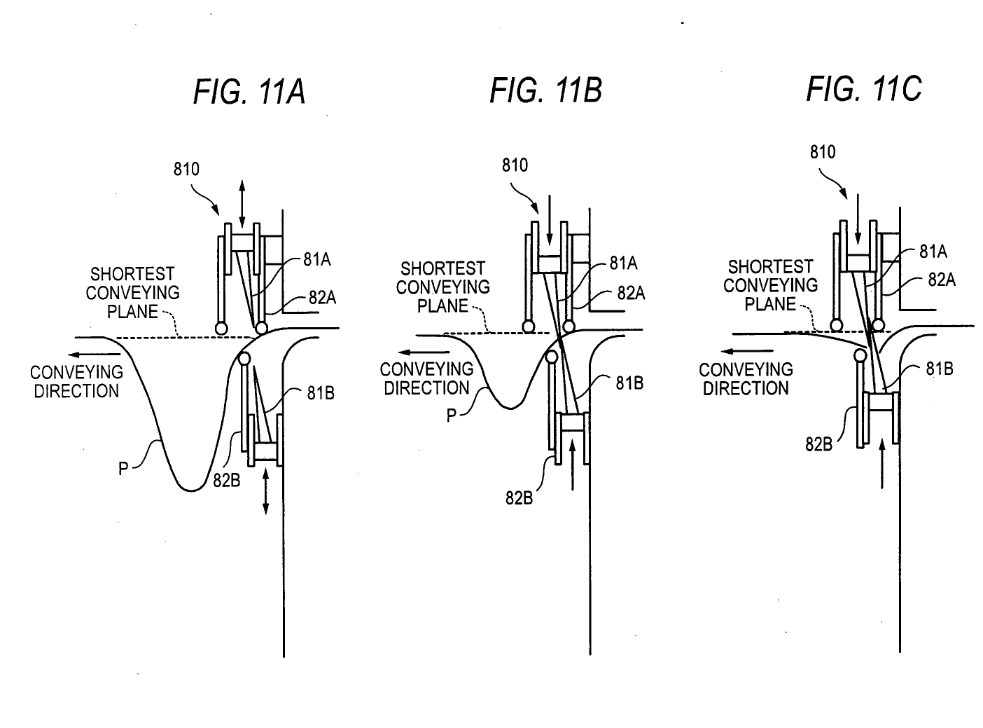

The structure of the first cutter 811 to the eighth cutter 818 (also generally called a “cutter 810”) will now be described. FIGS. 11A to 11C are diagrams for explaining the structure of the cutter 810.

As shown in FIGS. 11A to 11C, the cutter 810 in this embodiment includes: an upper cutter portion 81A, the blade edge of which is directed downward and can be moved vertically; an upper protective cover 82A that covers the blade edge of the upper cutter portion 81A; a lower cutter portion 81B, the blade edge of which is directed upward and can be moved vertically; and a lower protective cover 82B that covers the blade edge of the lower cutter portion 81A. The blade edge of the upper cutter portion 81A and the blade edge of the lower cutter portion 81B intersect, overlapping each other in the vicinity of the shortest conveying plane, explained in the first embodiment while referring to FIG. 7, so that the web P is cut in a direction almost perpendicular to the conveying direction.

Rotary cutters having circular blade edges that cut the web P while rotating can also be employed as the upper cutter portion 81A and the lower cutter portion 81B.

In this embodiment, in a state wherein the web P is being conveyed normally (FIG. 11A), the upper cutter portion 81A of the cutter 810 is so positioned that the blade edge is covered by the upper protective cover 82A, at a location vertically superior to the shortest conveying plane. And the lower cutter portion 81B is so positioned that the blade edge is covered by the lower protective cover 82B, at a location vertically inferior to the shortest conveying plane. Thus, the web P is prevented from contacting the blade edges of the upper cutter portion 81A and the lower cutter portion 81B, and an operator is protected from the blade edges of the upper cutter portion 81A and the lower cuter portion 81B.

Simultaneously, upon the occurrence of a conveying abnormality in the apparatus wherein the cutter 810 is arranged (FIG. 11B), the upper cutter portion 81A is activated and is projected downward, vertically, and the lower cutter portion 81B is activated and is projected upward, vertically.

Then, as the bend in the web P is gradually being reduced and the web P conveying path moves upward toward the shortest conveying plane, the upper cutter portion 81A and the lower cutter portion 81B engage the web P, in the vicinity of the shortest conveying plane of the web P, and cut it in a direction almost perpendicular to the conveying path (FIG. 11C).

As described above, in a condition wherein the web P is being normally conveyed, the blade edges of the upper cutter portion 81A and the lower cutter portion 81B of the cutter 810 are respectively covered by with the upper protective cover 82A and the lower protective cover 82B. But when a conveying abnormality occurs, the upper cutter portion 81A and the lower cutter portion 81B are activated and cut the web P in a direction substantially perpendicular to the conveying path. Thus, the web P is prevented from unnecessarily contacting the upper cutter portion 81A and the lower cutter portion 81B, and the operator is protected from the blade edges of the upper cutter portion 81A and the lower cuter portion 81b.

It should be noted that the operations of the first to the eighth cutters 811 to 818 are controlled by cutter controllers (which will be described later) provided for the respective cutters.

The web conveying processing performed by the printing system 2 of this embodiment will now be described.

According to the printing system 2 of this embodiment, the control computer 600, the feeding controller 310 of the web feeding apparatus 300, the K color printing controller 90K of the K color printer 150K, the first buffer unit controller 210A of the first buffer unit 200A, the C color printing controller 90C of the C color printer 150C, the second buffer unit controller 210B of the second buffer unit 200B, the M color printing controller 90M of the M color printer 150M, the third buffer unit controller 210C of the third buffer unit 200C, the Y color printing controller 90Y of the Y color printer 150Y, and the take-up controller 410 of the web take-up apparatus 400 cooperate to perform the web conveying operation.

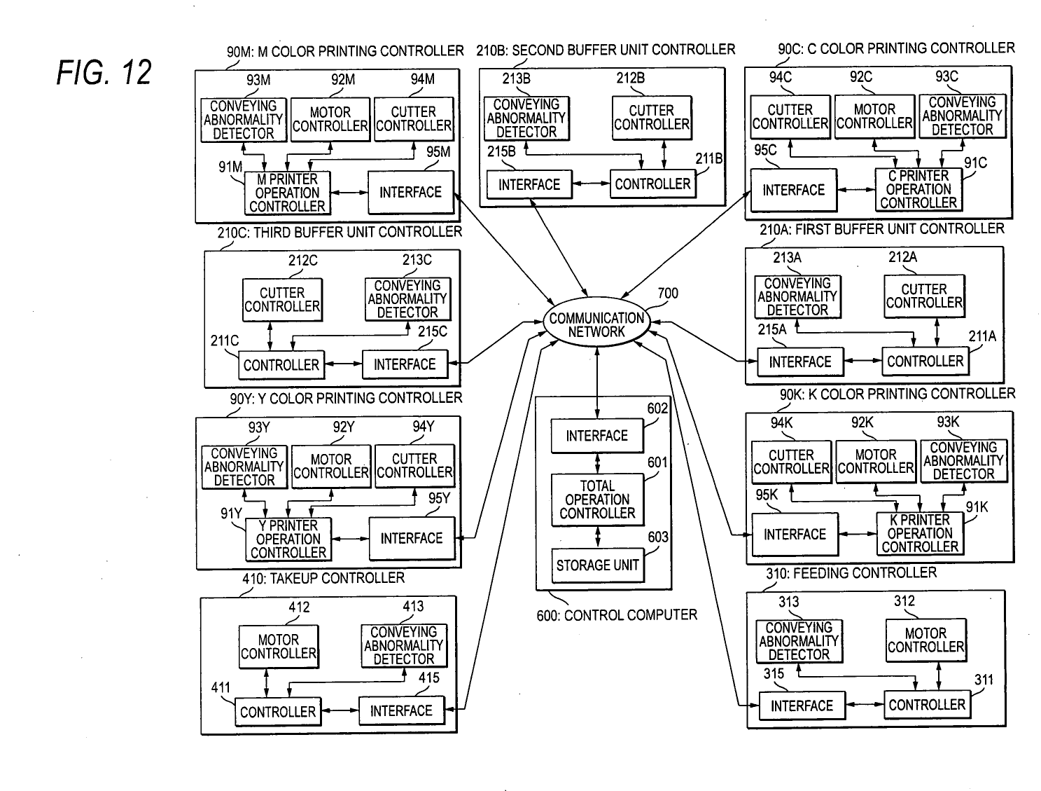

FIG. 12 is a diagram showing the arrangements of the functional sections related to conveying control of the control computer 600, the feeding controller 310, the K color printing controller 90K, the first buffer unit controller 210A, the C color printing controller 90C, the second buffer unit controller 210B, the M color printing controller 90M, the third buffer unit controller 210C, the Y printing controller 90Y and the take-up controller 410.

As shown in FIG. 12, first, the control computer 600 includes: a total operation controller 601, which provides overall control for the operations performed by the web feeding apparatus 300, the K color printer 150K, the first buffer unit 200A, the C color printer 150C, the second buffer unit 200B, the M color printer 150M, the third buffer unit 200C, the Y color printer 150Y and the web take-up apparatus 400; a storage unit 603, which stores, as an example, a control program that is executed by the total operation controller 601; and an interface 602, which controls data transmission/reception relative to the individual controllers via the communication network 700.

The feeding controller 310 includes: a controller 311, which monitors and controls overall operation of the web feeding apparatus 300; a motor controller 312, which controls the operation of a drive motor (not shown) for feeding the web P from the web roll 301; a conveying abnormality detector 313, which receives a conveying abnormality signal from the feeding abnormality detection sensor 304 and identifies the conveying abnormality that occurred in the web feeding apparatus 300; and an interface 315, which controls the transmission/reception of data, relative to the control computer 600, via the communication network 700.

The K color printing controller 90K includes: a K color printer operation controller 91K, which monitors and controls the operation of the conveying system of the K color printer 150K; a motor controller 92K, which controls the operation of a main motor (not shown) that is arranged in the K color printer 150K; a conveying abnormality detector 93K, which receives a conveying abnormality signal from the K color printer conveying abnormality detection sensor 154K and identifies the conveying abnormality that occurred in the K color printer 150K; a cutter controller 94K, which controls the operations of the first cutter 811 and the second cutter 812; and an interface 95K, which controls the transmission/reception of data exchanged with the control computer 600 via the communication network 700.

The first buffer unit controller 210A includes: a controller 211A, which monitors and controls the operation of the first buffer unit 200A; a conveying abnormality detector 213A, which receives a conveying abnormality signal from the first buffer conveying abnormality detection sensor 204A and identifies the conveying abnormality that occurred in the first buffer unit 200A; a cutter controller 212A, which controls the operation of the third cutter 813; and an interface 215A, which controls the transmission/reception of data exchanged with the control computer 600 via the communication network 700.

The C color printing controller 90C includes: a C color printer operation controller 91C, which monitors and controls the operation of the conveying system of the C color printer 150C; a motor controller 92C that controls the operation of a main motor (not shown) that is arranged in the C color printer 150C; a conveying abnormality detector 93C, which receives a conveying abnormality signal from a C color printer conveying abnormality detection sensor 154C and identifies the conveying abnormality that occurred in the C color printer 150C; a cutter controller 94C, which controls the operation of the fourth cutter 814; and an interface 95C, which controls the transmission/reception of data exchanged with the control computer 600 via the communication network 700.

The second buffer unit controller 210B includes: a controller 211B, which monitors and controls the operation of the second buffer unit 210B; a conveying abnormality detector 213B, which receives a conveying abnormality signal from the second buffer conveying abnormality detection sensor 204B and identifies the conveying abnormality that occurred in the second buffer unit 200B; a cutter controller 212B, which controls the operation of the fifth cutter 815; and an interface 215B, which controls the transmission/reception of data exchanged with the control computer 600 via the communication network 700.

The M color printing controller 90M includes: an M color printer operation controller 91M, which monitors and controls the operation of the conveying system of the M color printer 150M; a motor controller 92M, which controls the operation of a main motor (not shown) that is arranged in the M color printer 150M; a conveying abnormality detector 93M, which receives a conveying abnormality signal from an M color printer conveying abnormality detection sensor 154M and identifies the conveying abnormality that occurred in the M color printer 150M; a cutter controller 94M, which controls the operation of the sixth cutter 816; and an interface 95M, which controls the transmission/reception of data exchanged with the control computer 600 via the communication network 700.

The third buffer unit controller 210C includes: a controller 211C, which monitors and controls the operation of the third buffer unit 210C; a conveying abnormality detector 213C, which receives a conveying abnormality signal from the third buffer conveying abnormality detection sensor 204C and identifies the conveying abnormality that occurred in the third buffer unit 200C; a cutter controller 212C, which controls the operation of the seventh cutter 817; and an interface 215C, which controls the transmission/reception of data exchanged with the control computer 600 via the communication network 700.

The Y color printing controller 90Y includes: a Y color printer operation controller 91Y, which monitors and controls the operation of the conveying system of the Y color printer 150Y; a motor controller 92Y, which controls the operation of a main motor (not shown) that is arranged in the Y color printer 150Y; a conveying abnormality detector 93Y, which receives a conveying abnormality signal from a Y color printer conveying abnormality detection sensor 154Y and identifies the conveying abnormality that occurred in the Y color printer 150Y; a cutter controller 94Y, which controls the operation of the eighth cutter 818; and an interface 95Y, which controls the transmission/reception of data exchanged with the control computer 600 via the communication network 700.

The take-up controller 410 includes: a controller 411, which monitors and controls the overall operation of the web take-up apparatus 400; a motor controller 41, which controls the operation of a drive motor (not shown) that winds the web P around the take-up roll 401; a conveying abnormality detector 413, which receives a conveying abnormality signal from the take-up conveying abnormality detection sensor 404 and identifies the conveying abnormality that occurred in the web take-up apparatus 400; and an interface 415, which controls the transmission/reception of data, relative to the control computer 600, via the communication network 700.

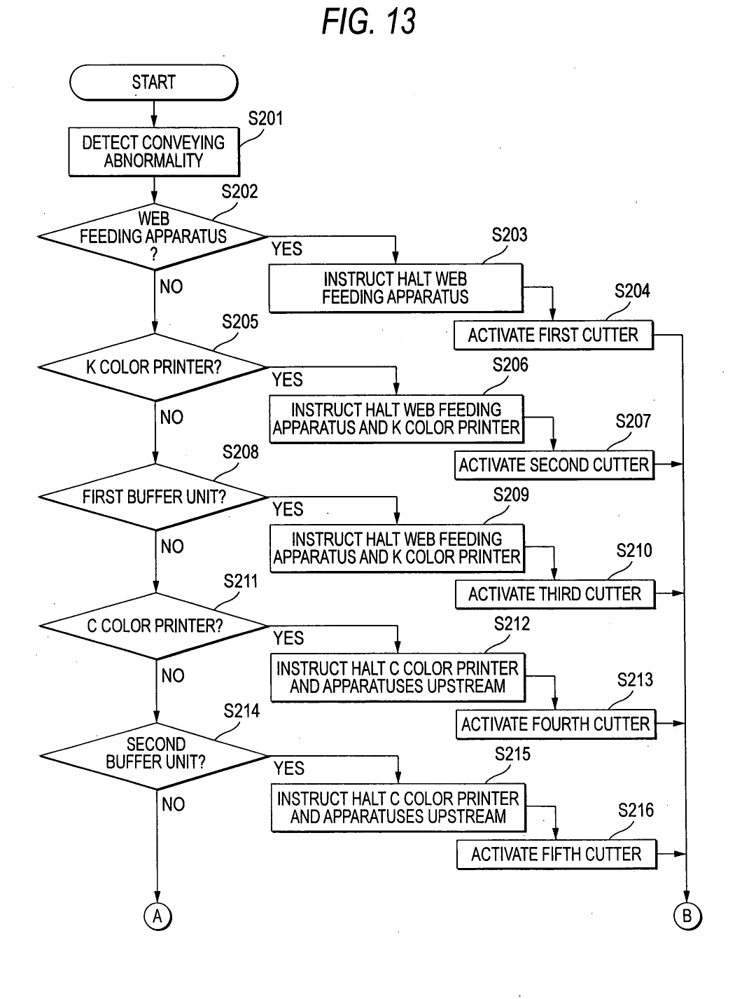

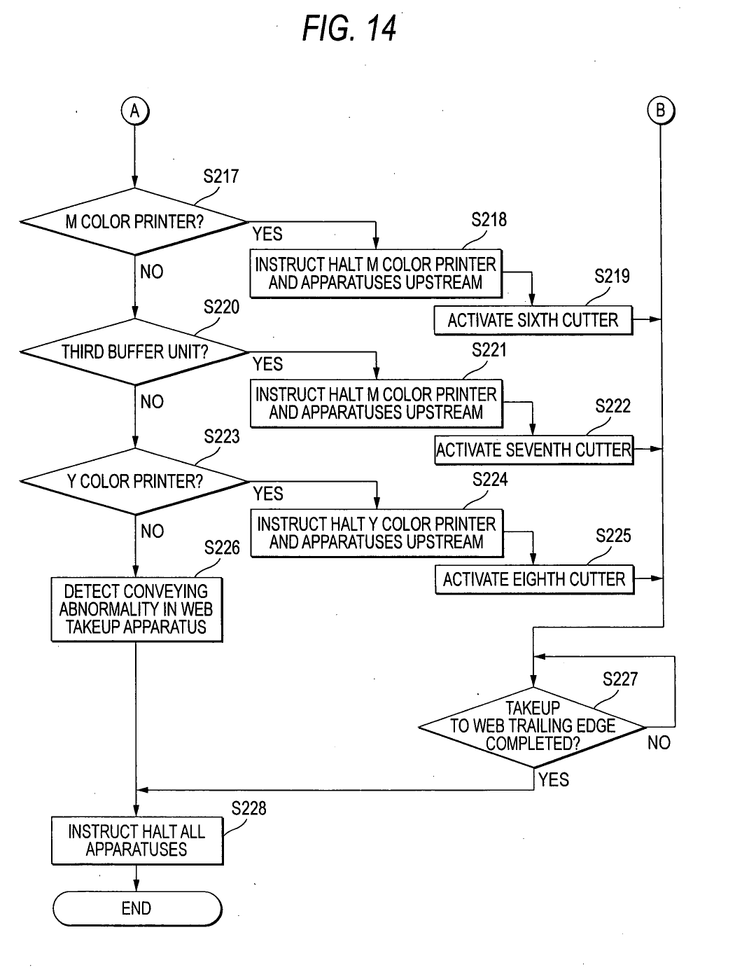

FIGS. 13 and 14 are flowcharts showing example web conveying processing performed by the printing system 2 of this embodiment. According to the printing system 2 of this embodiment, the total operation controller 601 of the control computer 600 controls the entire conveying operation using the individual apparatuses.

As shown in FIGS. 13 and 14, when a conveying abnormality is detected in one of apparatuses (S201), the total operation controller 601 of the control computer 600 identifies the apparatus at which the conveying abnormality occurred. When the total operation controller 601 identifies the conveying abnormality detected by the conveying abnormality detector 313 of the feeding controller 310 (S202), the total operation controller 601 issues an instruction to the controller 311 of the feeding controller 310 to halt the web feeding apparatus 300 (S203). In this fashion, the motor controller 312 of the feeding controller 310 halts the drive motor (not shown).

At the same time, the total operation controller 601 issues an instruction to the K color printing controller 90K of the K color printer 150K to activate the first cutter 811 (S204). Upon receiving the instruction, the cutter controller 94K of the K color printing controller 90K starts the first cutter 811 to cut the web P.

At this time, the apparatuses located downstream of the web feeding apparatus 300 in the conveying direction, i.e., the K color printer 150K to the web take-up apparatus 400, continue the conveying operation.

When the take-up controller 410 detects that the trailing edge of the web P cut by the first cutter 811 has reached the take-up roll 401 of the web take-up apparatus 400 and that the winding has been completed (S227), the total operation controller 601 of the control computer 600 issues an instruction to halt the entire printing system 2 (S228).

When the total operation controller 601 identifies the conveying abnormality detected by the conveying abnormality detector 93K of the K color printer 150K (S205), the total operation controller 601 issues an instruction to the controller 311 of the feeding controller 310 and the K color printer operation controller 91K of the K color printing controller 90K to halt the web feeding apparatus 300 and the K color printer 150K, respectively (S206) In this fashion, the motor controller 312 of the feeding controller 310 and the motor controller 92K of the K color printing controller 90K halt the drive motors (not shown).

At the same time, the total operation controller 601 issues an instruction to the K color printing controller 90K of the K color printer 150K to activate the second cutter 812 (S207). Upon receiving the instruction, the cutter controller 94K of the K color printing controller 90K starts the second cutter 812 to cut the web P.

At this time, the apparatuses located downstream of the K color printer 150K in the conveying direction, i.e., the first buffer unit 200A to the web take-up apparatus 400, continue the conveying operation.

When the take-up controller 410 detects that the trailing edge of the web P cut by the second cutter 812 has reached the take-up roll 401 of the web take-up apparatus 400 and that the winding has been completed (S227), the total operation controller 601 of the control computer 600 issues an instruction to halt the entire printing system 2 (S228).

When the total operation controller 601 identifies the conveying abnormality detected by the conveying abnormality detector 213K of the first buffer unit 200A (S208), the total operation controller 601 issues an instruction to the controller 311 of the feeding controller 310 and the K color printer operation controller 91K of the K color printing controller 90K to halt the web feeding apparatus 300 and the K color printer 150K, respectively (S209). In this fashion, the motor controller 312 of the feeding controller 310 and the motor controller 92K of the K color printing controller 90K halt the drive motors (not shown).

At the same time, the total operation controller 601 issues an instruction to the first buffer unit controller 210A of the first buffer unit 200A to activate the third cutter 813 (S210). Upon receiving the instruction, the cutter controller 212A of the first buffer unit controller 210A starts the third cutter 813 to cut the web P.

At this time, the apparatuses located downstream of the first buffer unit 200A in the conveying direction, i.e., the C color printer 150C to the web take-up apparatus 400, continue the conveying operation.

When the take-up controller 410 detects that the trailing edge of the web P cut by the third cutter 813 has reached the take-up roll 401 of the web take-up apparatus 400 and that the winding has been completed (S227), the total operation controller 601 of the control computer 600 issues an instruction to halt the entire printing system 2 (S228).

When the total operation controller 601 identifies the conveying abnormality detected by the conveying abnormality detector 93C of the C color printer 150C (S211), the total operation controller 601 issues an instruction to the controller 311 of the feeding controller 310, the K color printer operation controller 91K of the K color printing controller 90K and the C color printer operation controller 91C of the C color printing controller 90C to halt the web feeding apparatus 300, the K color printer 150K and the C color printer 150C, respectively (S212). In this fashion, the motor controller 312 of the feeding controller 310, the motor controller 92K of the K color printing controller 90K and the motor controller 92C of the C color printing controller 90C halt the drive motors (not shown).

At the same time, the total operation controller 601 issues an instruction to the C color printing controller 90C of the C color printer 150C to activate the fourth cutter 814 (S213). Upon receiving the instruction, the cutter controller 94C of the C color printing controller 90C starts the fourth cutter 814 to cut the web P.

At this time, the apparatuses located downstream of the C color printer 150C in the conveying direction, i.e., the second buffer unit 200B to the web take-up apparatus 400, continue the conveying operation.

When the take-up controller 410 detects that the trailing edge of the web P cut by the fourth cutter 814 has reached the take-up roll 401 of the web take-up apparatus 400 and that the winding has been completed (S227), the total operation controller 601 of the control computer 600 issues an instruction to halt the entire printing system 2 (S228).

When the total operation controller 601 identifies the conveying abnormality detected by the conveying abnormality detector 213B of the second buffer unit 200B (S214), the total operation controller 601 issues an instruction to the controller 311 of the feeding controller 310, the K color printer operation controller 91K of the K color printing controller 90K and the C color printer operation controller 91C of the C color printing controller 90C to halt the web feeding apparatus 300, the K color printer 150K and the C color printer 150C, respectively (S215). In this fashion, the motor controller 312 of the feeding controller 310, the motor controller 92K of the K color printing controller 90K and the motor controller 92C of the C color printing controller 90C halt the drive motors (not shown).

At the same time, the total operation controller 601 issues an instruction to the second buffer unit 210B of the second buffer unit 200B to activate the fifth cutter 815 (S216). Upon receiving the instruction, the cutter controller 212B of the second buffer unit controller 210B starts the fifth cutter 815 to cut the web P.

At this time, the apparatuses located downstream of the second buffer unit 200B in the conveying direction, i.e., the M color printer 150M to the web take-up apparatus 400, continue the conveying operation.

When the take-up controller 410 detects that the trailing edge of the web P cut by the fifth cutter 815 has reached the take-up roll 401 of the web take-up apparatus 400 and that the winding has been completed (S227), the total operation controller 601 of the control computer 600 issues an instruction to halt the entire printing system 2 (S228).

When the total operation controller 601 identifies the conveying abnormality detected by the conveying abnormality detector 93M of the M color printer 150M (S217), the total operation controller 601 issues an instruction to the controller 311 of the feeding controller 310, the K color printer operation controller 91K of the K color printing controller 90K, the C color printer operation controller 91C of the C color printing controller 90C and the M color printer operation controller 91M of the M color printing controller 90M to halt the web feeding apparatus 300, the K color printer 150K, the C color printer 150C and the M color printer 150M respectively (S218). In this fashion, the motor controller 312 of the feeding controller 310, the motor controller 92K of the K color printing controller 90K, the motor controller 92C of the C color printing controller 90C and the M motor controller 92M of the M color printing controller 90M halt the drive motors (not shown).

At the same time, the total operation controller 601 issues an instruction to the M color printing controller 90M of the M color printer 150M to activate the sixth cutter 816 (S219). Upon receiving the instruction, the cutter controller 94M of the M color printing controller 90M starts the sixth cutter 816 to cut the web P.

At this time, the apparatuses located downstream of the M color printer 150M in the conveying direction, i.e., the third buffer unit 200C to the web take-up apparatus 400, continue the conveying operation.

When the take-up controller 410 detects that the trailing edge of the web P cut by the sixth cutter 816 has reached the take-up roll 401 of the web take-up apparatus 400 and that the winding has been completed (S227), the total operation controller 601 of the control computer 600 issues an instruction to halt the entire printing system 2 (S228).

When the total operation controller 601 identifies the conveying abnormality detected by the conveying abnormality detector 213C of the third buffer unit 200C (S220), the total operation controller 601 issues an instruction to the controller 311 of the feeding controller 310, the K color printer operation controller 91K of the K color printing controller 90K, the C color printer operation controller 91C of the C color printing controller 90C and the M color printer operation controller 91M of the M color printing controller 90M to halt the web feeding apparatus 300, the K color printer 150K, the C color printer 150C and the M color printer 150M respectively (S221). In this fashion, the motor controller 312 of the feeding controller 310, the motor controller 92K of the K color printing controller 90K, the motor controller 92C of the C color printing controller 90C and the M motor controller 92M of the M color printing controller 90M halt the drive motors (not shown).

At the same time, the total operation controller 601 issues an instruction to the third buffer unit controller 210C of the third buffer unit 200C to activate the seventh cutter 817 (S222). Upon receiving the instruction, the cutter controller 212C of the third buffer unit controller 210C starts the seventh cutter 817 to cut the web P.

At this time, the apparatuses located downstream of the third buffer unit 200C in the conveying direction, i.e., the Y color printer 150Y and the web take-up apparatus 400, continue the conveying operation.

When the take-up controller 410 detects that the trailing edge of the web P cut by the seventh cutter 817 has reached the take-up roll 401 of the web take-up apparatus 400 and that the winding has been completed (S227), the total operation controller 601 of the control computer 600 issues an instruction to halt the entire printing system 2 (S228).

When the total operation controller 601 identifies the conveying abnormality detected by the conveying abnormality detector 93Y of the Y color printer 150Y (S223), the total operation controller 601 issues an instruction to the controller 311 of the feeding controller 310, the K color printer operation controller 91K of the K color printing controller 90K, the C color printer operation controller 91C of the C color printing controller 90C, the M color printer operation controller 91M of the M color printing controller 90M and the Y color printer operation controller 91Y of the Y color printing controller 90Y to halt the web feeding apparatus 300, the K color printer 150K, the C color printer 150C, the M color printer 150M and the Y color printer 150Y, respectively (S224). In this fashion, the motor controller 312 of the feeding controller 310, the motor controller 92K of the K color printing controller 90K, the motor controller 92C of the C color printing controller 90C, the M motor controller 92M of the M color printing controller 90M and the motor controller 92Y of the Y color printing controller 90Y halt the drive motors (not shown).

At the same time, the total operation controller 601 issues an instruction to the Y color printing controller 90Y of the Y color printer 150Y to activate the eighth cutter 818 (S225). Upon receiving the instruction, the cutter controller 94Y of the Y color printing controller 90Y starts the eighth cutter 818 to cut the web P.

At this time, the apparatus located downstream of the Y color printer 150Y in the conveying direction, i.e., the web take-up apparatus 400 continues the conveying operation.

When the take-up controller 410 detects that the trailing edge of the web P cut by the eighth cutter 818 has reached the take-up roll 401 of the web take-up apparatus 400 and that the winding has been completed (S227), the total operation controller 601 of the control computer 600 issues an instruction to halt the entire printing system 2 (S228).

When the total operation controller 601 of the control computer 600 determines that a conveying abnormality has been detected by the conveying abnormality detector 413 of the web take-up apparatus 400 (S226), the total operation controller 601 issues an instruction to halt all the apparatuses (S228).

As described above, according to the printing system 2 of the embodiment, when a web conveying abnormality due to the jamming of the web P or an operating error is detected in one of the web feeding apparatuses 300, the K color printer 150K, the first buffer unit 200A, the C color printer 150C, the second buffer unit 200B, the M color printer 150M, the third buffer unit 200C, the Y color printer 150Y and the web take-up apparatus 400, the control computer 600 immediately halts the apparatus at the location whereat the conveying abnormality was detected and all apparatuses located upstream of that apparatus in the conveying direction. At the same time, the web P is cut by activating the uppermost cutter that is located downstream, in the conveying direction, of the apparatus whereat the conveying abnormality was detected, i.e., the cutter that is located downstream, in the conveying direction, nearest the apparatus whereat the conveying abnormality was detected. The operation of an apparatus located downstream, in the conveying direction, of the apparatus whereat the conveying abnormality was detected is halted when the trailing cut edge of the web P has been collected.

Through this processing, since the image forming operation continues to be performed for the portion of the web P that has already passed through the apparatus whereat the conveying abnormality was detected, and is present downstream of this apparatus, the amount of the web P that is wasted, i.e., a so-called “paper loss”, is reduced. Further, since an unfixed image is not present on the side downstream of the apparatus at which the conveying abnormality was detected, image defacing inside the apparatus can be prevented. In addition, since the web P does not remain downstream of the apparatus at which the conveying abnormality was detected, for the printing system 2, the number of steps required of an operator to perform a recovery operation is reduced

The second cutter 812 may be located at the web entrance port of the first buffer unit 200A, and the third cutter 813 maybe located at the web entrance port of the C color printer 150C. The fourth cutter 814 may be located at the web entrance port of the second buffer unit 200B, and the fifth cutter 815 may be located at the web entrance port of the M color printer 150M. The sixth cutter 816 may be located at the web entrance port of the third buffer unit 200C, and the seventh cutter 817 may be located at the web entrance port of the Y color printer 150Y. However, in order to reduce paper loss, it is more effective for these cutters be located on the upstream side of the individual apparatuses.

What is claimed is:

1. A printing system comprising:
a plurality of image forming units that forms an image on a recording medium; and
a plurality of cutting units that are arranged at a plurality of locations along a conveying path in which the images are formed on the recording medium, the conveying path conveying the recording medium to the plurality of image forming units, and that cuts the recording medium based on a state where the recording medium is being conveyed.

2. The printing system as claimed in claim 1, further comprising:
a controller that controls both the conveying of the recording medium and operating of each of the plurality of cutting units,
wherein, in a case where a conveying abnormality of the recording medium occurs, the controller controls each of the plurality of cutting units to cut the recording medium at a first location at which the conveying abnormality of recording medium occurs or at a second location downstream of the first location, and the controller controls the cutting unit to halt the conveying of the recording medium in an area upstream of a cutting location at which the cutting unit is to cut the recording medium and to continue the conveying of the recording medium in an area downstream of the cutting location.

3. The printing system as claimed in claim 1, further comprising:
a controller that controls the conveying of the recording medium,
wherein, in a case where a conveying abnormality of the recording medium occurs, the controller halts the conveying of the recording medium at a first location at which the conveying abnormality of the recording medium occurs and at a third location upstream of the first location, and continues the conveying of the recording medium in a second location downstream of the first location, and
the cutting unit is arranged at locations at which the cutting unit contacts the recording medium in a state where the controller halts the conveying of the recording medium at the first location and the third location, and continues the conveying of the recording medium in the second location.

4. The printing system as claimed in claim 1, wherein the cutting unit is arranged downstream of locations at which image forming performed by the image forming unit has been completed.

5. The printing system as claimed in claim 1, further comprising:
a recording medium conveying unit that is disposed between the plurality of image forming units and conveys the recording medium with a slackness,
wherein
the cutting unit is arranged in the substantially vicinity of the recording medium conveying unit.

6. The printing system as claimed in claim 1, wherein the cutting unit comprises:
a blade that cuts the recording medium; and
a protective member that covers the blade and avoids touching the recording medium conveyed in the conveying path.

7. The printing system according to claim 1, wherein, in a case where a conveying abnormality of the recording medium occurs, the cutting unit is moved in a direction in which the blade contacts the recording medium.

8. An image forming apparatus comprising:
an image forming unit that forms an image on a recording medium;
a conveying unit that conveys the recording medium on which an image is formed by the image forming unit; and
a cutting unit that cuts the recording medium in accordance with a state where the recording medium is being conveyed by the conveying unit.

9. The image forming apparatus as claimed in claim 8, wherein a cutting width that the cutting unit cuts the recording medium in a direction perpendicular to a conveying direction of the recording medium is greater than a width of the recording medium.

10. The image forming apparatus as claimed in claim 8, further comprising:
a controller that controls operation of the conveying unit,
wherein, when a conveying abnormality of the recording medium occurs in an external apparatus conveying the recording medium that the conveying unit conveys, the controller permits the conveying unit to continue the conveying of the recording medium in a case where the external apparatus is located upstream of the image forming apparatus in a conveying direction of the recording medium, and
the controller permits the conveying unit to halt the conveying of the recording medium in a case where the external apparatus is located downstream of the image forming apparatus in the conveying direction of the recording medium.

11. The image forming apparatus as claimed in claim 9, wherein the cutting unit is arranged at a location at which the cutting unit contacts the recording medium when the conveying unit is halted by the controller.

12. The image forming apparatus as claimed in claim 9, wherein the cutting unit contacts the recording unit when the conveying unit is halted by the controller.

13. A control apparatus comprising:
a cutting unit that is located along a conveying path for conveying the recording medium and cut the recording medium;
a cutting controller that, in a case where a conveying abnormality is detected, controls the cutting unit that is arranged at a first location at which the conveying abnormality of the recording medium occurs or at a second location downstream of the first location to cut the recording medium; and
a conveying controller that controls the conveying of the recording medium such that the conveying of the recording medium is halted in an area upstream of a cutting location at which the recording medium is cut by the cutting unit, and the conveying of the recording medium is continued in an area downstream of the cutting location.

14. A computer readable medium storing a program causing a computer to execute a process for forming an image, the process comprising:
controlling, when an abnormality of conveying a recoding medium on which an image is to be formed is detected, a cutting unit to cut the recording medium, the cutting unit being located along a conveying path for conveying the recording medium and is arranged at a first location at which the conveying abnormality occurs or at a second location downstream of the first location, and
controlling the conveying of the recording medium such that the conveying of the recording medium is halted in an area upstream of a cutting location at which the recording medium is cut by the cutting unit, and the conveying of the recording medium is continued in an area downstream of the cutting location.

15. A computer data signal embodied in a carrier wave for enabling a computer to perform a process for forming an image, the process comprising:
controlling, when an abnormality of conveying a recoding medium on which an image is to be formed is detected, a cutting unit to cut the recording medium, the cutting unit being located along a conveying path for conveying the recording medium and is arranged at a first location at which the conveying abnormality occurs or at a second location downstream of the first location, and
controlling the conveying of the recording medium such that the conveying of the recording medium is halted in an area upstream of a cutting location at which the recording medium is cut by the cutting unit, and the conveying of the recording medium is continued in an area downstream of the cutting location.

16. An image forming method comprising:
controlling, when an abnormality of conveying a recoding medium on which an image is to be formed is detected, a cutting unit to cut the recording medium, the cutting unit being located along a conveying path for conveying the recording medium and is arranged at a first location at which the conveying abnormality occurs or at a second location downstream of the first location, and
controlling the conveying of the recording medium such that the conveying of the recording medium is halted in an area upstream of a cutting location at which the recording medium is cut by the cutting unit, and the conveying of the recording medium is continued in an area downstream of the cutting location.
